(19) United States
(12) Patent Application Publication
(10) Pub. No.: US 2007/0283183 A1
(43) Pub. Date: Dec. 6, 2007

(54) APPARATUS, METHOD AND CIRCUIT FOR GENERATING CLOCK, AND APPARATUS, METHOD AND PROGRAM FOR VERIFYING OPERATION

(75) Inventor: Shigehisa Komoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/840,608

(22) Filed: Aug. 17, 2007

Related U.S. Application Data
(63) Continuation of application No. PCT/JP2005/002615, filed on Feb. 18, 2005.

(51) Int. Cl. G06F 1/00

(52) U.S. Cl. 713/500

(57) ABSTRACT

One or more clock generating units generating a plurality of clock signals are included and, when the clock generating operation is returned from a stop state to an operating state, the clock generating unit generates the clock signal corresponding to the phase at the time of stop. Since a status is not changed when such clock signals are used to stop or restart the operation of the verification target apparatus, operation information can continuously be acquired and recorded for a long time.

### CROSS-REFERENCE TO RELATED APPLICATIONS

This application is a continuation of International Application No. PCT/JP2005/002615, filed on Feb. 18, 2005, now pending, herein incorporated by reference.

### BACKGROUND OF THE INVENTION

1. Field of the Invention

The present invention relates to a clock generating apparatus, a clock generating method, a clock generating circuit, an operation verifying apparatus, an operation verifying method, and an operation verifying program suitable for longtime operation verification of hardware such as LSI (Large Scale Integration) and FPGA (Field Programmable Gate Arrays).

2. Description of the Related Art

Hardware such as LSI and FPGA is generally operated with a plurality of asynchronous clocks because of large scale and SOC (system on chip). To verify operation of such hardware, the hardware must be operated by applying a test signal for achieving the operation to observe various operational signals such as internal signals and external output signals of the hardware. However, the operation verification of hardware requiring a plurality of asynchronous clocks is very complicated because of maintenance of conditions such as observation time, observation signal, and a phase relationship among a plurality of asynchronous clocks.

Conventionally, in such operation verification, a verifying system is configured by connecting a verification target apparatus with a signal generator, a clock generating apparatus, a logic analyzer, etc., and a signal generated by the signal generator and a plurality of clock signals generated by the clock generating apparatus are applied to the verification target apparatus to store internal signals and output signals generated from the verification target apparatus into a signal storage apparatus. The clock signals used in this verification are clock signals having the actual speed of the verification target apparatus or clock signals having lower speed to facilitate the verification, and the clock signals are continuously applied to the verification target apparatus during one verification period.

By the way, with regard to this type of operation verification, patent documents include a micro program trace apparatus (Japanese Patent Application Laid-Open Publication No. 58-181154) that stops a clock applied externally to a storage apparatus when a write space runs out in the verification target storage apparatus and that restarts the clock after the reading of the storage apparatus is completed, and an in-circuit emulator (Japanese Patent Application Laid-Open Publication No. 11-259329) of a micro controller operated with a plurality of asynchronous clocks.

By the way, since a storage volume becomes enormous due to signals acquired from a verification target apparatus and the storage volume becomes enormous also due to the number of stored signals when verification operation is continuously performed, the recording time of the verification result is restricted automatically. Even when the number of stored signals is made constant, a storage capacity must be increased in a storage apparatus storing signals to prolong the recording time of signals.

To record signals acquired from a verification target apparatus operated at high speed, a high-speed device is needed such as a semiconductor memory accommodating the high-speed operation, and a storage capacity is restricted. Therefore, if a storage capacity is insufficient for signals, the same verification must be repeated and the required verification time must be divided to store the signals.

The output signals of the verification target apparatus may be stored in a small-capacity storage apparatus; when reaching the limit of the storage apparatus, the supply of the clock may be stopped to suspend the operation of the verification target apparatus; the stored signal may be transferred from the storage apparatus to a large-capacity storage apparatus; and the supply of the clock may be restarted to continue the operation. In a verification target apparatus operated with a plurality of clocks, if the supply of the clocks is simply stopped and restarted, a phase relationship may be broken among a plurality of clocks when the supply of the clocks is restarted, and the operation after restarting the clocks may be varied from actual operation achieved by not stopping the clocks. Such operation verification is senseless and the clocks must not be stopped and restarted without much thought.

To generate clocks retaining a phase relationship among a plurality of clocks when restarting the supply of clocks, a phase of each clock may be stored when clocks are stopped, and the supply of the clocks may be restarted from the stored phase at the time of restart, while such operation cannot practically be achieved at a high clock speed.

Since Japanese Patent Application Laid-Open Publication No. 58-181154 does not disclose or indicate such problems and Japanese Patent Application Laid-Open Publication No. 11-259329 discloses and indicates only a certain case, the problems cannot be solved by the inventions disclosed in Japanese Patent Application Laid-Open Publication Nos. 58-181154 and 11-259329.

### SUMMARY OF THE INVENTION

A first object of the present invention relates to suspension and restart of a plurality of clock signals and is to prevent a phase relationship of the clock signals from being discontinued when the clock signals are suspended and restarted.

A second object of the present invention relates to operation verification requiring a plurality of clock signals and is to realize longtime recording of operational signals.

To achieve the above objects, a clock generating apparatus of the present invention comprises one or more clock generating units that generate a plurality of clock signals, and the clock generating unit continuously generates the clock signal corresponding to a phase at a time of stop in case that clock generating operation is returned from a stop state to an operating state.

According to such structure, the clock generating operation of one or more clock generating units can arbitrarily be stopped; the operation can be restarted to generate the clock signals; and the phase relationship of the clock signals can be retained regardless of the stop and restart of the generation. The operation can be stopped and restarted for various apparatuses requiring such clock signals without changing the operation condition.

To achieve the above objects, a clock generating apparatus of the present invention may comprise one or more clock generating units that generate a plurality of clock signals, and the clock generating unit may continuously generate the clock signal corresponding to a phase at a time of stop in case that clock generating operation is switched by a control signal and the clock generating operation is returned from a stop state to an operating state. According to such structure, the control signal can be used to stop and restart the clock signal generating operation. The phase relationship associated with the stop and restart of the clock signals can be maintained regardless of the control.

To achieve the above objects, in the clock generating apparatus of the present invention, the clock generating unit may include a storage unit that stores the phase of the clock signal at the time of stopping the clock generating operation and the clock signal may continuously be generated based on the phase stored in the storage unit.

To achieve the above objects, a clock generating apparatus of the present invention may comprise a master clock generating unit that generates a master clock signal and one or more clock generating units that generate a plurality of clock signals from the master clock signal of the master clock generating unit, and the clock generating unit may continuously generate the clock signal corresponding to a phase at a time of stop in case that clock generating operation is switched by a control signal and the clock generating operation is returned from a stop state to an operating state.

To achieve the above objects, a clock generating method of the present invention comprises one or more clock generating units that generate a plurality of clock signals, and the method comprises the process of continuously generating the clock signal corresponding to a phase at a time of stop in case that clock generating operation is returned from a stop state to an operating state. According to such structure, the clock generating operation of one or more clock generating units can arbitrarily be stopped; the operation can be restarted to generate the clock signals; and the phase relationship of the clock signals can be retained regardless of the stop and restart of the generation.

To achieve the above objects, a clock generating method of the present invention comprises the processes of allowing a master clock generating unit to generate a master clock signal; allowing one or more clock generating units to generate a plurality of clock signals from the master clock signal; and allowing the clock generating unit to continuously generate the clock signal corresponding to a phase at a time of stop in case that clock generating operation is switched by a control signal and the clock generating operation is returned from a stop state to an operating state.

To achieve the above objects, a clock generating circuit of the present invention comprises one or more clock generating units that generate a plurality of clock signals, and the circuit generates the clock signal corresponding to a phase at a time of stop in case that clock generating operation is returned from a stop state to an operating state. According to such structure, the clock generating operation of one or more clock generating units can arbitrarily be stopped; the operation can be restarted to generate the clock signals; and the phase relationship of the clock signals can be retained regardless of the stop and restart of the generation. The operation can be stopped and restarted for various apparatuses requiring such clock signals without changing the operation condition.

To achieve the above objects, a clock generating circuit of the present invention may comprise a master clock generating unit that generates a master clock signal; and one or more clock generating units that generate a plurality of clock signals from the master clock signal of the master clock generating unit, the clock generating unit continuously generating the clock signal corresponding to a phase at a time of stop in case that clock generating operation is switched by a control signal and the clock generating operation is returned from a stop state to an operating state.

To achieve the above objects, an operation verifying apparatus of the present invention. is an operation verifying apparatus that applies clock signals and an input signal necessary for a verification target apparatus to verify operation of the verification target apparatus and comprises an input signal generating unit that generates the input signal necessary for the verification target apparatus; a clock generating apparatus that generates a plurality of clock signals necessary for the verification target apparatus; and an output signal storage unit that stores an output signal acquired from the verification target apparatus. The clock generating apparatus includes one or more clock generating units that generate a plurality of clock signals. The clock generating unit continuously generates the clock signal corresponding to a phase at a time of stop in case that clock generating operation is controlled by a control signal and the clock generating operation is returned from a stop state to an operating state.

According to such structure, the operation of the verification target apparatus can be stopped and restarted by the above clock signal generating operation and the stop and restart of the generating operation, and since the operation condition is not changed, the continuity of the verification operation of the verification target apparatus can be maintained and the operation recording can be performed for a long time to improve the credibility of the operation verification.

To achieve the above objects, in the operation verifying apparatus of the present invention, the input signal generating unit may include a storage unit that stores the input signal applied to the verification target apparatus, and the input signal generating unit may apply the control signal to the clock generating apparatus correspondingly to readout and read-in of the input signal of the storage unit to control the clock generating operation.

To achieve the above objects, in the operation verifying apparatus of the present invention, the output signal storage unit may apply the control signal to the clock generating apparatus correspondingly to read-in or readout of the output signal of the verification target apparatus to control the clock generating operation.

To achieve the above objects, an operation verifying method of the present invention is an operation verifying method of applying clock signals and an input signal necessary for a verification target apparatus to verify the operation of the verification target apparatus and comprises the processes of allowing an input signal generating unit to generate the input signal necessary for the verification target apparatus; allowing a clock generating apparatus to generate a plurality of clock signals necessary for the verification target apparatus; allowing an output signal storage unit to store an output signal acquired from the verification target apparatus; allowing one or more clock generating units included in the clock generating apparatus to generate a plurality of clock signals; and allowing the clock generating unit to continuously generate the clock signal corresponding to a phase at a time of stop in case that clock generating operation is controlled by a control signal and the clock generating operation is returned from a stop state to an operating state. According to such structure, the operation of the verification target apparatus can be stopped and restarted by the above clock signal generating operation and the stop and restart of the generating operation, and since the operation condition is not changed, the continuity of the verification operation of the verification target apparatus can be maintained and the operation recording can be performed for a long time to improve the credibility of the operation verification.

To achieve the above objects, in the operation verifying method of the present invention, the input signal generating unit may include a storage unit that stores the input signal applied to the verification target apparatus, and the method may comprise the process of allowing the input signal generating unit to apply the control signal to the clock generating apparatus correspondingly to readout and read-in of the input signal of the storage unit to control the clock generating operation.

To achieve the above objects, the operation verifying method of the present invention may further comprise the process of allowing the output signal storage unit to apply the control signal to the clock generating apparatus correspondingly to read-in or readout of the output signal of the verification target apparatus to control the clock generating operation.

To achieve the above objects, an operation verifying program of the present invention is an operation verifying program of applying clock signals and an input signal necessary for a verification target apparatus to verify operation of the verification target apparatus, and allows a computer to perform the steps of allowing an input signal generating unit to generate the input signal necessary for the verification target apparatus; allowing a clock generating apparatus to generate a plurality of clock signals necessary for the verification target apparatus; allowing an output signal storage unit to store an output signal acquired from the verification target apparatus; allowing one or more clock generating units included in the clock generating apparatus to generate a plurality of clock signals; and allowing the clock generating unit to continuously generate the clock signal corresponding to a phase at a time of stop in case that clock generating operation is controlled by a control signal and the clock generating operation is returned from a stop state to an operating state. According to such structure, the operation of the verification target apparatus can be stopped and restarted by the above clock signal generating operation and the stop and restart of the generating operation, and since the operation condition is not changed, the continuity of the verification operation of the verification target apparatus can be maintained and the operation recording can be performed for a long time to improve the credibility of the operation verification.

To achieve the above objects, in the operation verifying program of the present invention, the input signal generating unit may include a storage unit that stores the input signal applied to the verification target apparatus, and the program may allow the computer to perform the step of allowing the input signal generating unit to apply the control signal to the clock generating apparatus correspondingly to readout and read-in of the input signal of the storage unit to control the clock generating operation.

To achieve the above objects, in the operation verifying program of the present invention, the program may allow the computer to perform the step of applying the control signal to the clock generating apparatus correspondingly to read-in or readout of the output signal of the verification target apparatus to control the clock generating operation.

The features and advantages of the present invention are as follows.

(1) According to a clock generating apparatus, a clock generating method, or a clock generating circuit, a plurality of clock signals is acquired; a phase relationship at the time of stopping the clock signals can be maintained when the generation of the clock signals is restarted; and the phase relationship of the clock signals can be maintained regardless of the generation and stop of the clock signals and the restart of the generation.

(2) According to an operation verifying apparatus, an operation verifying method, and an operation verifying program according to the present invention, even when a plurality of clock signals required for normal operation of a verification target apparatus is supplied, stopped, or restarted, a phase relationship among generated clock signals is retained, i.e., the relationship of the required number of the clocks is retained among the clocks during any period except the clock stop time, and therefore, even when the operation of the verification target apparatus is stopped and restarted due to the supply, stop, and restart of the clock signals, the operation continuity can be maintained, and the operation recording can be performed for a long time in the same way as the operation verification recording without discontinuation of the operation

Other objects, features, and advantages of the present invention will become more apparent by reference to the accompanying drawings and the embodiments.

### BRIEF DESCRIPTION OF THE DRAWINGS

FIG. 1 is a circuit diagram of a clock generating apparatus according to a first embodiment of the present invention.

FIG. 2 is a timing chart of an input/output relationship of a gate unit.

FIG. 3 is a timing chart of generation timings of clock signals.

FIG. 4 is a list of a configuration example of a clock generating unit described in a hardware description language.

FIG. 5 is a circuit diagram of the configuration example of the clock generating unit.

FIG. 6 is a flowchart of the clock signal generating operation of the clock generating unit.

FIG. 7 is a flowchart of the clock signal generating operation of the clock generating unit.

FIG. 8 is a list of a configuration example of the clock generating unit described in a hardware description language.

FIG. 9 is a circuit diagram of the configuration example of the clock generating unit.

FIG. 10 is a flowchart of the clock signal generating operation of the clock generating unit.

FIG. 11 is a list of a configuration example of a clock generating apparatus according to a second embodiment of the present invention.

FIG. 12 is a timing chart of operation and generated clock signals.

FIG. 13 is a circuit diagram of a configuration example of hardware of the clock generating apparatus.

FIG. 14 is a flowchart of clock gating operation.

FIG. 15 is a flowchart of clock gating operation.

FIG. 16 is a flowchart of clock gating operation.

FIG. 17 is a flowchart of the clock signal generating operation of the clock generating unit.

FIG. 18 is a flowchart of the clock signal generating operation of the clock generating unit.

FIG. 19 is a flowchart of the clock signal generating operation of the clock generating unit.

FIG. 20 is a block diagram of an operation verifying apparatus according to a third embodiment of the present invention.

FIG. 21 is a diagram of a control operation sequence.

FIG. 22 is a block diagram of an operation verifying system according to a fourth embodiment of the present invention.

FIG. 23 is a block diagram of a configuration example of a verification control PC.

FIG. 24 is a block diagram of an example of a verification target apparatus.

FIG. 25 is a block diagram of a variation of the operation verifying system according to the fourth embodiment of the present invention.

### DETAILED DESCRIPTION OF THE PREFERRED EMBODIMENTS

### First Embodiment

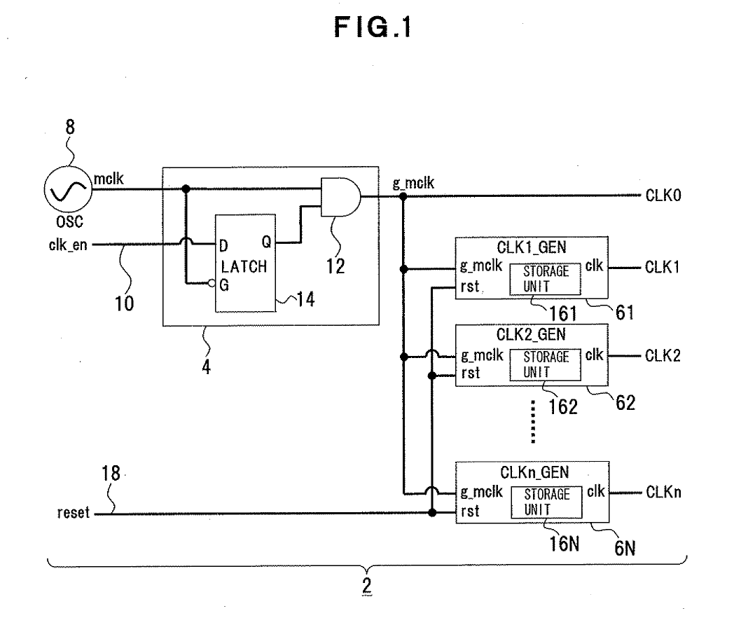

A first embodiment of the present invention will be described with reference to FIG. 1. FIG. 1 is a circuit diagram of a clock generating apparatus 2 according to the first embodiment.

The clock generating apparatus 2 is disposed with a gate unit 4 and one or more clock generating units, which are a plurality of clock generating units (CLK1_GEN, CLK2_GEN, . . . CLKn_GEN) 61, 62, . . . 6N in this embodiment. A clock oscillator (OSC) 8 is disposed on the preceding stage of the gate unit 4; a master clock signal mclk is supplied to the gate unit 4 from the OSC 8; and a clock generation control signal clk_en is applied from a control input terminal 10. From the clock generating units 61, 62, . . . 6N, a plurality of generated clock signals CLK1, CLK2, . . . CLKn is acquired based on a gating master clock signal g_mclk acquired from the gate unit 4. The gating master clock signal g_mclk acquired from the gate unit 4 is directly taken out as a clock signal CLK0 from the gate unit 4. Therefore, CLK0, CLK1, CLK2, . . . CLKn can be acquired from the clock generating apparatus 2.

With regard to the relationship between g_mclk (gating master clock signal) and each of CLK0, CLK1, CLK2, . . . CLKn (generated clock signal), g_mclk and CLK0 are a common clock signal, and each of CLK0, CLK1, CLK2, . . . CLKn has an independent clock frequency and a different number of required clocks per unit time. CLK1, CLK2, . . . CLKn are different from g_mclk and have different numbers of clocks per unit time so as to cope with applications such as when the signals are used as clock signals necessary for operation verification of a verification target apparatus such as a portable phone described as follows.

In the clock generating apparatus 2, the gate unit 4 is configured by an AND circuit 12 and a latch circuit (LATCH) 14. To the LATCH 14, clk_en (clock generation control signal) is applied at an input D and mclk (master clock signal) is applied at an inverted input G. The clock generation control signal clk_en is, for example, a switching signal having two levels, which are high and low (H/L) levels, and is a control signal that controls passage of mclk.

The clock generating units 61 to 6N receive g_mclk from the gate unit 4 and generate CLK1, CLK2, . . . CLKn (generated clock signal) based on g_mclk. In the clock generating units 61 to 6N, clock cycles are updated at either or both of the rising and falling edges of g_mclk; if a clock generated in each clock cycle actually is a clock with a constant clock width, it is determined whether a clock pulse is generated; and if a clock is generated, a clock pulse is generated in accordance with the timing of changes in g_mclk to generate CLK1, CLK2, . . . CLKn (generated clock signal). Each clock generation unit 61 to 6N is disposed with a storage unit 161, 162, . . . 16N and each storage unit stores the phase information of CLK1, CLK2, . . . CLKn. That is, when clk_en is canceled and g_mclk is canceled, the generation of CLK1, CLK2, . . . CLKn is stopped, and when the generation is stopped, the phase information of CLK1, CLK2, . . . CLKn is stored and retained in the storage units 161 to 16N and used as the phase information when restarting the clock generation. To the clock generating units 61 to 6N, a common reset signal reset is applied through a reset input terminal 18, and the phase information in the storage units 161 to 16N is reset to a default value by the reset. That is, the clock generating units 61 to 6N are initialized. The reset circuit is not necessarily needed.

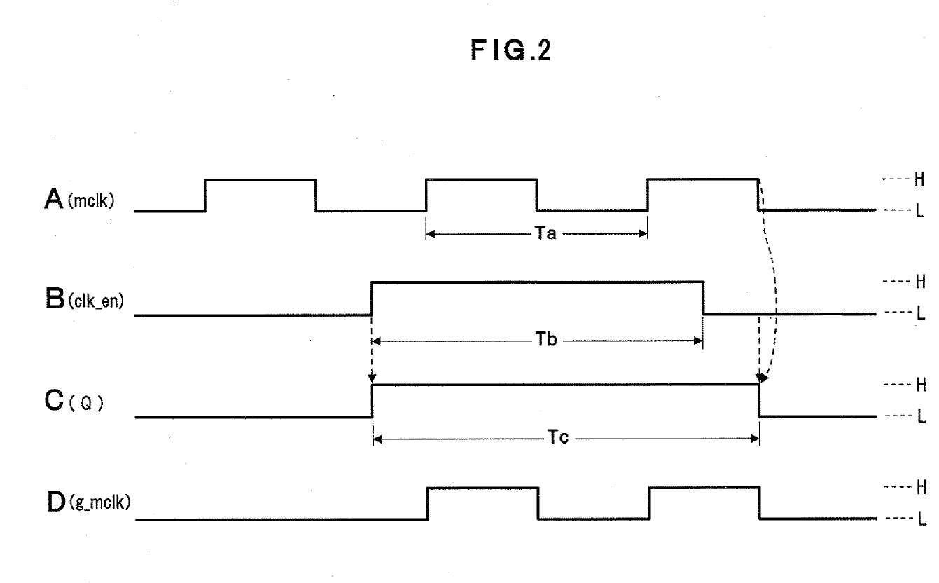

The operation of the clock generating apparatus 2 will be described with reference to FIG. 2. FIG. 2 is a timing chart of an input/output relationship of the gate unit 4.

To the gate unit 4, mclk (master clock signal) shown by A of FIG. 2 and clk_en (clock generation control signal) shown by B of FIG. 2 are supplied. In this case, clk_en is a signal that is at H-level for a period Tb longer than a cycle Ta of mclk. In such an input relationship, the LATCH 14 can acquire an output Q shown by C of FIG. 2. When the output Q and mclk are supplied to the AND circuit 12, mclk is gated during an H-level period Tc of the output Q and g_mclk shown by D of FIG. 2 can be acquired. This g_mclk is taken out as CLK0 (generated clock signal), supplied to the clock generating unit 61 to 6N, and used as a basis for generating CLK1, CLK2, . . . CLKn (generated clock signals).

Therefore, CLK1, CLK2, . . . CLKn are generated from the clock generating units 61 to 6N in the H-level period Tb of clk_en. The above phase information of CLK1, CLK2, . . . CLKn for g_mclk is stored in the storage units 161 to 16N, and when clk_en is shifted to L-level and g_mclk is stopped, the phase information of CLK1, CLK2, . . . CLKn at this time point is stored and retained in the storage units 161 to 16N. The stored conditions are retained unless the conditions are reset by the reset (reset signal).

When clk_en is shifted to H-level and g_mclk is restarted, the generation of CLK1, CLK2, . . . CLKn is restarted with the phase information retained in the storage units 161 to 16N, and CLK0 is concurrently generated.

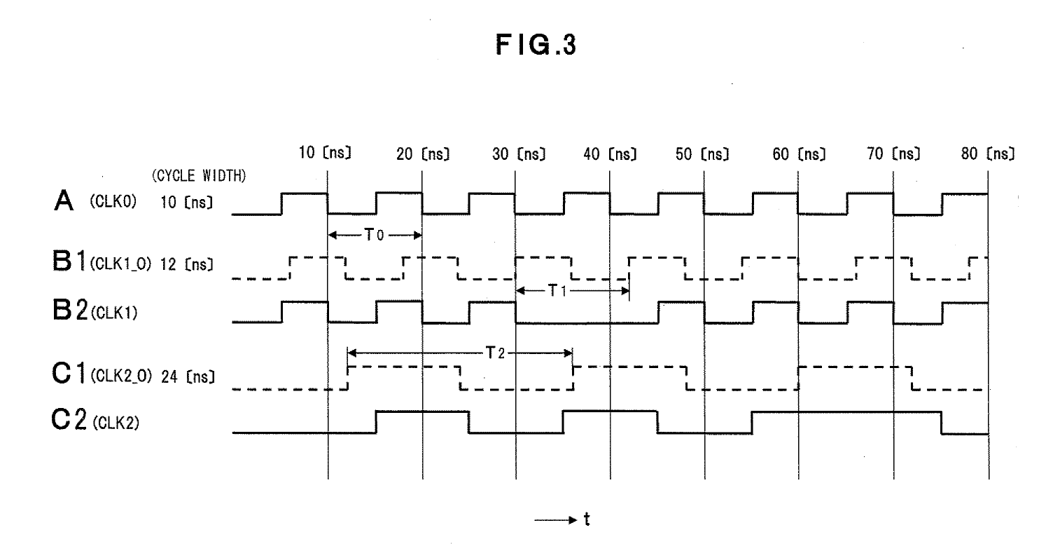

Such operation of the gate unit 4 and the clock generating units 61 to 6N will be described with reference to FIG. 3. FIG. 3 is a timing chart of commonly used constant-frequency clock signals CLK1_0 and CLK2_0, and CLK1 and CLK2 generated by the clock generating units 61 and 62. CLK1_0 and CLK2_0 are explanatory hypothetical clock signal.

In FIG. 3, CLK0 shown by A is equivalent to g_mclk and is a generated clock signal having a generated clock width (cycle width) T0 of 10 [ns], for example. CLK1_0 shown by B1 is a constant-frequency clock signal having a clock cycle time T1 of 12 [ns], and CLK1 shown by B2 is a clock signal of the embodiment corresponding to B1. CLK2_0 shown by C1 is a constant-frequency clock signal having a clock cycle time T2 of 24 [ns], and CLK2 shown by C2 is a clock signal of the embodiment corresponding to C1.

In such time setting, the edges of pulses of CLK0, CLK1_0 and CLK2_0 become identical at a time point of a time width Tx (=120 [ns]), which is the least common multiple of T0 (=10 [ns]), T1 (=12 [ns]), and T2 (=24 [ns] ) . From the time width Tx, the clock numbers N0, N1, and N2 of CLK0, CLK1_0, and CLK2_0 are as follows.
N0Tx/T0=120 [ns]/10 [ns]=12 (1)
N1=Tx/T1=120 [ns]/12 [ns]=10 (2)
N2=Tx/T2=120 [ns]/24 [ns]=5 (3)
These numbers represent the clock numbers per certain period of time. The values of the clock number N are an example and the clock number N can be set to a desirable value by arbitrarily setting the cycle width.

The clock generating units 61 and 62 generate CLK1 (B2 of FIG. 3) and CLK2 (C2 of FIG. 3), which have the same clock number N as the clock number N required per unit time. Although CLK1 (B2 of FIG. 3) and CLK2 (C2 of FIG. 3) are partially omitted clock signals as compared to the constant-frequency g_mclk (gating master clock signal) and each clock pulse is an integral multiple of the master clock, since a clock with a clock number required for each clock frequency can be acquired in any time zone that is the least common multiple of the clock cycle, it can be considered that the phase and the clock number are matched and therefore, no problem occurs due to the differences in the waveforms.

With regard to CLK1 and CLK2, a phase relative to CLK0, i.e., time difference information of clock edges is stored in the storage units 161 and 162, and when g_mclk is stopped, the relationship information is retained until the supply of g_mclk is restarted and is used as the start information at the time of restart.

In the clock generating apparatus 2, a clock signal having the highest frequency is defined as mclk (master clock signal). In the gate unit 4, mclk is gated by clk_en to generate or stop CLK0, CLK1, CLK2, . . . CLKn (generated clock signal). CLK0 is generated by the gate unit 4, and CLK1, CLK2, . . . CLKn are generated from g_mclk by the clock generating unit 61 to 6N. If the generation and stop of g_mclk is controlled by clk_en to stop CLK0 as well as CLK1, CLK2, . . . CLKn, when g_mclk is supplied, CLK0, CLK1, CLK2, . . . CLKn are generated from this time point.

As described above, in the clock generating units 61 to 6N, clock cycles are updated at either or both of the rising and falling edges of g_mclk; if a clock generated in each clock cycle actually is a clock with a constant clock width, it is determined whether a clock pulse is generated; and if a clock signal is generated, a clock pulse is generated in accordance with the timing of changes in g_mclk to generate CLK1, CLK2, . . . CLKn.

Therefore, in accordance with the clock generating apparatus 2, a plurality of signals CLK0, CLK1, CLK2, . . . CLKn (generated clock signals) can be generated, stopped, and restarted with the phase relationship maintained. Although a constant-frequency clock signal is generally used as each clock and the partially omitted clock signals are acquired in this embodiment, no problem occurs in practical use.

In accordance with the clock generating apparatus 2 including such a function, mclk (master clock signal) with a constant cycle width can be used to generate one or more clock signals CLK1, CLK2, . . . CLKn corresponding to respective clock frequency, and when mclk is stopped and restarted, one or more clock signals CLK0, CLK1, CLK2, . . . CLKn can continuously be generated without discontinuity in the phase relationship and generated clock numbers of CLK1, CLK2, . . . CLKn generated at the time of restart.

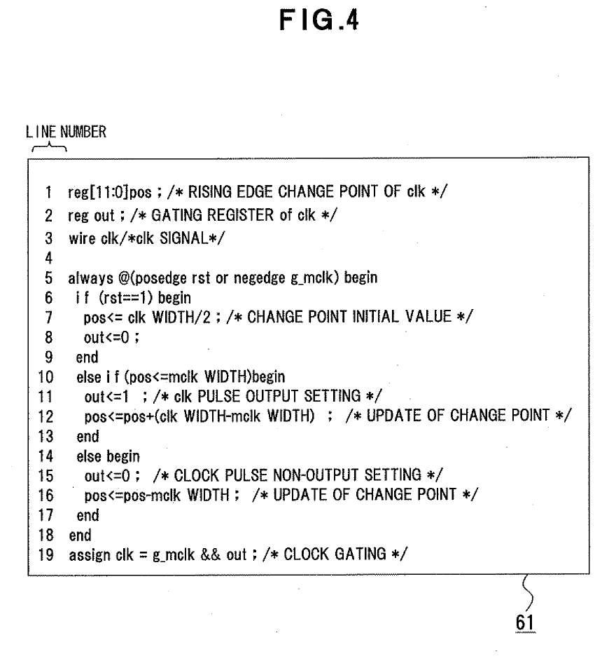

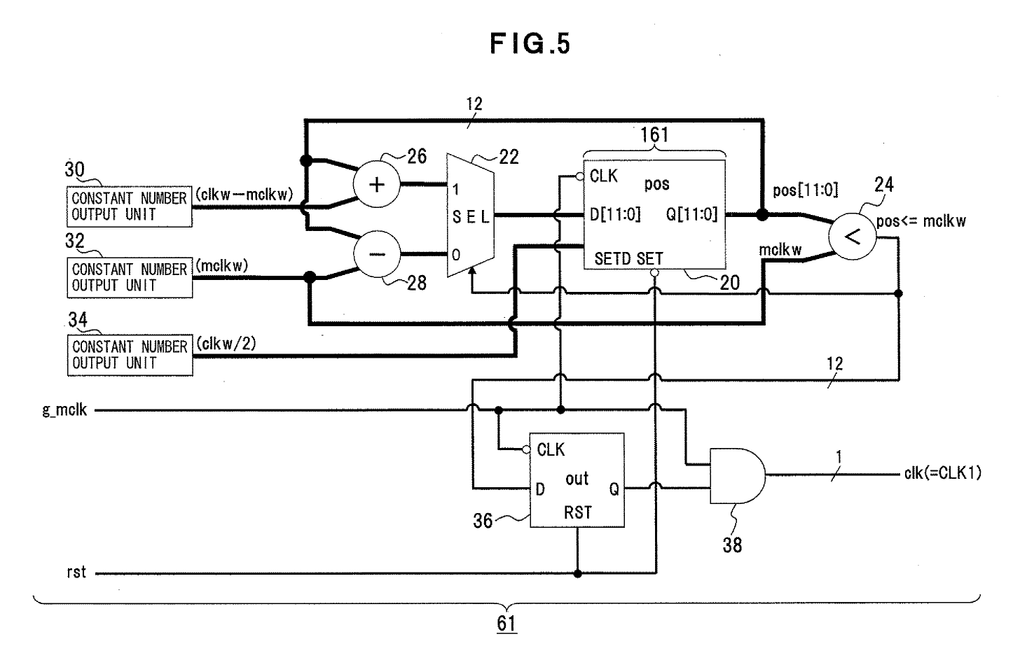

An embodiment of the clock generating unit 61 of the clock generating apparatus 2 will be described with reference to FIGS. 4 and 5. FIG. 4 is a list of a configuration example of the clock generating unit 61 described in a hardware description language (by way of example, Verilog HDL) and FIG. 5 is a circuit diagram of the configuration example of the clock generating unit 61.

In the case of this configuration example of the clock generating unit 61, the frequency (f=1/T) of the generated clock signal CLK1 exceeds ½ of the master clock signal mclk. With reference to the timing chart shown in FIG. 3, since the clock signal CLK0 has the cycle width T0 of 10 [ns] as shown by A of FIG. 3 and the clock signals CLK1_0 and CLK1 have the cycle width T1 of 12 [ns] as shown by B1 and B2 of FIG. 3, the cycle width T1 of the clock signal CLK1 is a value smaller than a doubled cycle width T0 of the clock signal CLK0 (T1<2T0), and therefore, the relationship conforms to the above condition.

The clock generating unit 61 configured in conformity with this condition is described in the hardware description language (Verilog HDL) as follows (FIG. 4). In this list, process contents are described along with line numbers.

| | |
|---|---|
| 1 | reg[11:0]pos;/*rising edge change point of clk*/ |
| 2 | reg out;/*Gating Register of clk*/ |
| 3 | wire clk/*clk signal*/ |
| 4 | (blank) |
| 5 | always@ (posedge rst or negedge g_mclk)begin |

| | |
|---|---|
| 6 | if(rst==1)begin |

| | |
|---|---|
| 7 | pos<=clk width/2;/*change point initial value*/ |
| 8 | out<=0; |

| | |
|---|---|
| 9 | end |

| | |
|---|---|
| 10 | else if(pos<=mclk width)begin |

| | |
|---|---|
| 11 | out<=1;/*clk pulse output setting*/ |
| 12 | out<=pos+(clk width−mclk width);/*update of |

change point*/

| | |
|---|---|
| 13 | end |
| 14 | else begin |

| | |
|---|---|
| 15 | out<=0;/*Clock pulse non-output setting*/ |
| 16 | pos<=pos−mclk width;/*update of change point*/ |

| | |
|---|---|
| 17 | end |

| | |
|---|---|
| 18 | end |
| 19 | assign clk=g_mclk && out;/*Clock Gating*/ |

In this list, the line numbers 1 to 3 are declaration of register and signal, and the line numbers 5 to 19 represent processes. The “[11:0]” represents a 12-bit configuration, and the “pos” is a register indicating a change point (time) of the rising edge of a clock signal having a constant clock width and configures the above storage unit 161. The “out” is a register that gates the master clock signal mclk. The “rst” is the above reset signal reset. The “clk” is a generated clock signal. The “g_mclk” is the master clock signal that is gated. The “if” represents comparison.

In the clock generating unit 61 represented by this list, when the rst is input, a change point set to the register (pos) is initially set to ½ of a generated clock width, and the register (out) is set to “0” (state of not generating a clock). The initial value of the register (pos) may be any values equal to or less than the generated clock width. It is determined whether the output value of the register (pos) is equal to or less than the clock signal width of the master clock signal mclk at the rising edge of g_mclk (10th line), and if the value is equal to or less than the clock signal width, the register (out) is set to “1” (pulse is generated) and the value of the register (pos) is updated by adding (generated clock signal width−clock width of master clock signal mclk) to the output value of the register (pos) (11th and 12th lines). If the output value of the register (pos) exceeds the clock width of the maser clock signal mclk, the register (out) is set to “0”, and the clock width of the maser clock signal mclk is subtracted from the register (pos) (15th and 16th lines). The generated clock signal (clk) is formed by gating g_mclk with the register (out) (19th line)

The clock generating unit 61 is configured as shown in FIG. 5 by converting the description in the hardware description language (Verilog HDL) into hardware.

The clock generating unit 61 is disposed with a register (pos) 20 configuring the storage unit 161, and the register 20 is configured by a multi-bit D-FF. To the CLK input of the register 20, g_mclk is inverted and supplied. A selector (SEL) 22 is disposed on the D input side of the register 20, and a comparator 24 is disposed on the output Q side. An adder 26 and a subtracter 28 are disposed on the preceding stage of the selector 22; the outputs of the adder 26 and the subtracter 28 are selected by the output value of the comparator 24; and the selected output is supplied to the register 20. The comparator 24 compares the output value pos[11:0] of the register 20 and the master clock signal width mclkw to determine whether the output value pos is within the clock signal width mclkw; if the value is within the clock signal width mclkw, the selector 22 selects “1” (pulse is generated); and if the value exceeds the clock signal width mclkw, the selector 22 selects “0”. To the register 20, the output value of the adder 26 is supplied if “1” is selected and the output value of the subtracter 28 is supplied if “0” is selected. The adder 26 adds the output value pos of the register 20 and a value of (generated clock signal width−master clock signal width) (clkw−mclkw), and the subtracter 28 subtracts the master clock signal width mclkw from the output value pos of the register 20. At the time of reset, a one-half value of the generated clock signal width (clkw/2) is set as the initial value of the register 20. Clkw−mclkw is supplied by a constant number output unit 30 disposed on the preceding stage of the adder 26; mclkw is supplied by a constant number output unit 32 disposed on the preceding stage of the subtracter 28; and clkw/2 is supplied by a constant number output unit 34. The register 20 is supplied with rst (reset signal=reset).

A register (out) 36 is disposed on the output side of the comparator 24; the output of the comparator 24 is supplied to the D input of the register 36; and the gating master clock signal g_mclk is inverted and input to the CLK input; and rst (reset signal=reset) is supplied to the RST input. An AND circuit 38 is disposed on the output side of the register 36 and the AND circuit 38 is supplied with the output Q of the register 36 and g_mclk. The generated clock signal clk (=CLK1) can be acquired from the AND circuit 38.

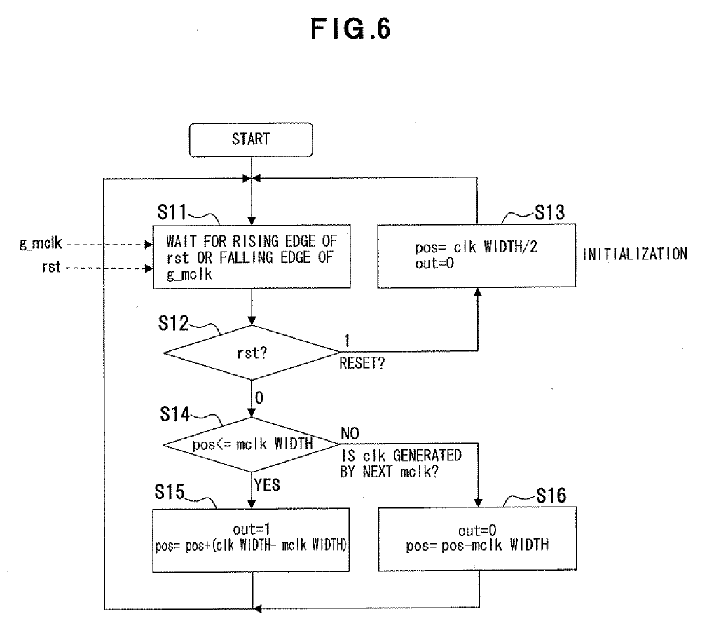

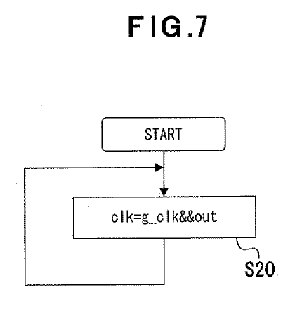

The operation of the clock generating unit 61 will be described with reference to FIGS. 6 and 7. FIGS. 6 and 7 are flowcharts of the clock signal generating operation of the clock generating unit 61 shown in FIGS. 4 and 5.

At the start of operation, the clock generating unit 61 waits for the rising edge of rst or falling edge (edge) of g_mclk (step S11). In this case, the execution of rst and the cancellation of rst are defined as “1” and “0”, respectively, and the determination is performed (step S12). In the case of rst=1, the reset process of the registers 20 and 36 is performed to initialize the setting values of the registers 20 and 36 (step S13). In this case, after the constant number output unit 34 sets clkw/2 for the register 20 and out=0 for the register 36, the flow is goes back to step S11. When rst=1 is cancelled and the falling edge of g_mclk occurs, the comparison process of the comparator 24 is performed after step S12 (step S14). The output value pos of the register 20 is compared with the master clock signal width mclkw. In this comparison process, it is determined whether clk is generated by the next mclk. In the case of pos≦mclkw, out=1 is set, and pos=pos+(clkw−mclkw) is set (step S15). In the case of pos>mclkw, out=0 is set, and pos=pos−mclkw is set (step S16). With such a process, CLK1 is generated by the clock generating unit 61..

Since CLK1 is acquired from logical multiplication of g_mclk and the output value out of the register 36 by the AND circuit 38, a process shown in FIG. 7 is performed, and this process (step S20) represents that if either g_mclk or out is changed, CLK1 is changed to the logical sum thereof.

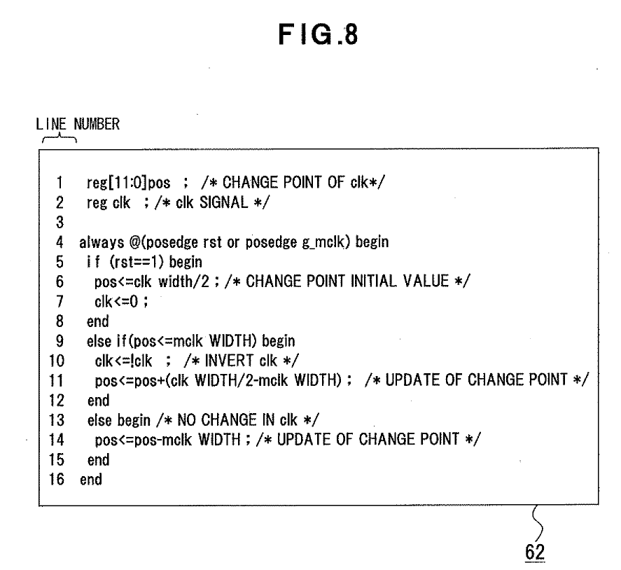

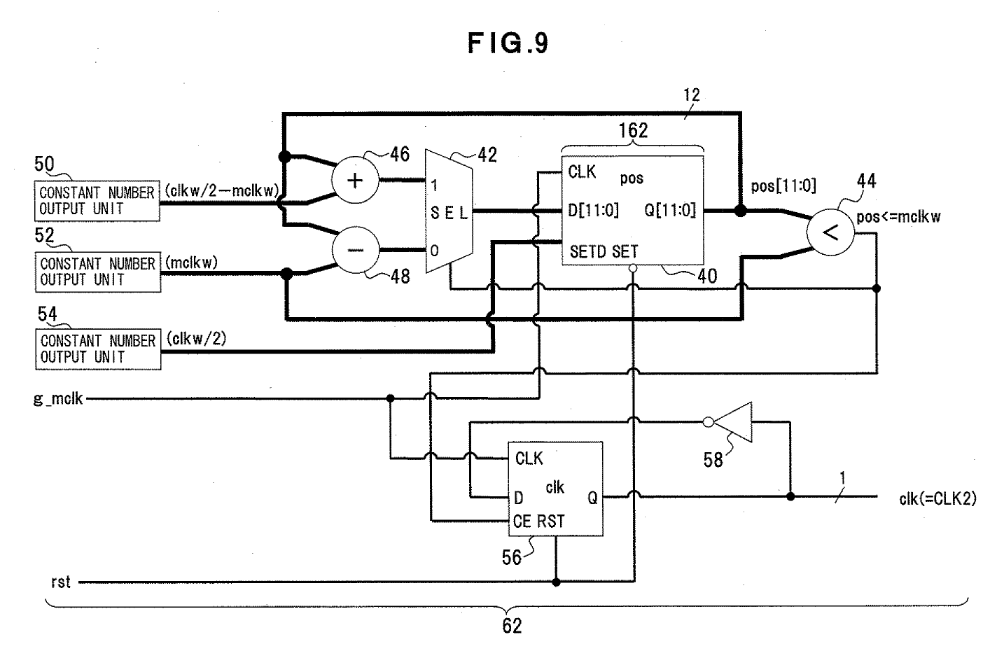

An embodiment of the clock generating unit 62 of the clock generating apparatus 2 will be described with reference to FIGS. 8 and 9. FIG. 8 is a list of a configuration example of the clock generating unit 62 described in the hardware description language (Verilog HDL) and FIG. 9 is a circuit diagram of the configuration example of the clock generating unit 62.

In the case of this configuration example of the clock generating unit 62, the frequency (f=1/T) of the generated clock signal CLK2 is equal to or less than ½ of the master clock signal mclk. With reference to the timing chart shown in FIG. 3, since the clock signal CLK0 has the cycle width T0 of 10 [ns] as shown by A of FIG. 3 and the clock signals CLK2_0 and CLK2 have the cycle width T2 of 24 [ns] as shown by C1 and C2 of FIG. 3, the cycle width T2 of the clock signal CLK2 is a value greater than a doubled cycle width T0 of the clock signal CLK0 (T2≧2T0), and therefore, the relationship conforms to the above condition.

The clock generating unit 62 configured in conformity with this condition is described in the hardware description language (Verilog HDL) as follows (FIG. 8). In this list, process contents are described along with line numbers as is the case with the above clock generating unit 61.

| | |
|---|---|
| 1 | reg[11:0]pos;/*change point of clk*/ |
| 2 | reg clk;/*clk signal*/ |
| 3 | (blank) |
| 4 | always@(posedge rst or posedge g_mclk)begin |

| | |
|---|---|
| 5 | if(rst==1)begin |

| | |
|---|---|
| 6 | pos<=clk width/2;/*change point initial value*/ |
| 7 | clk<=0; |

| | |
|---|---|
| 8 | end |
| 9 | else if(pos<=mclk width)begin |

| | |
|---|---|
| 10 | clk<=!clk;/*invert clk*/ |
| 11 | pos<=pos+(clk width/2−mclk width);/*update of |

| change point*/ | |
|---|---|
| 12 | end |
| 13 | else begin/*no change in clk*/ |

| | |
|---|---|
| 14 | pos<=pos−mclk width;/*update of change point*/ |

| | |
|---|---|
| 15 | end |

| | |
|---|---|
| 16 | end |

In this list, the line numbers 1 and 2 are declaration of register and signal, and the line numbers 4 to 16 represent processes. The “[11:0]” represents a 12-bit configuration, and the “pos” is a register indicating a change point (time) of the rising edge or falling edge of a clock signal having a constant clock width and configures the above storage unit 162. The “out” is a register that gates the master clock signal mclk. The “rst” is the above reset signal reset. The “clk” is a generated clock signal. The “g_mclk” is the master clock signal that is gated. The “if” represents comparison.

In the clock generating unit 62 represented by this list, when the rst is input, pos is initially set to ½ of a generated clock width, and clk is set to “0” (pulse is not generated). The initial value of pos may be any values except ½ of the generated clock width as is the case with the clock generating unit 61.

It is determined whether pos is equal to or less than the clock signal width of the master clock signal mclk at the rising edge of g_mclk (9th line), and if pos is equal to or less than the clock signal width mclkw, clk is inverted, and pos is updated by adding (generated clock signal width/2−clock width of mclk) to pos (10th and 11th lines). If pos exceeds the clock signal width of mclk, the clock signal width of mclk is subtracted from pos (14th line).

Since the clock generating unit 62 checks the rising edge and falling edge times of the generated clock signal for each cycle of mclk, the duty of the generated clock signal is near 50% as compared to the clock generating unit 61.

The clock generating unit 62 is configured as shown in FIG. 9 by converting the description in the hardware description language (Verilog HDL) into hardware.

The clock generating unit 62 is disposed with a register (pos) 40 configuring the storage unit 162, and the register 40 is configured by a multi-bit D-FF. To the CLK input of the register 40, the gating master clock signal g_mclk is supplied. A selector 42 is disposed on the D input side of the register 40, and a comparator 44 is disposed on the output Q side. An adder 46 and a subtracter 48 are disposed on the preceding stage of the selector 42; the outputs of the adder 46 and the subtracter 48 are selected by the output value of the comparator 44; and the selected output is supplied to the register 40. The comparator 44 compares the output value pos[11:0] of the register 40 and the master clock signal width mclkw to determine whether the output value pos is equal to or less than the master clock signal width mclkw; if the value is equal to or less than the clock signal width mclkw, the selector 42 selects “1” (pulse is generated); and if the value exceeds the clock signal width mclkw, the selector 42 selects “0”. To the register 40, the output value of the adder 46 is supplied if “1” is selected and the output value of the subtracter 48 is supplied if “0” is selected. The adder 46 adds the output value pos of the register 40 and a value of (generated clock signal width/2−master clock signal width) (clkw/2−mclkw), and the subtracter 48 subtracts the master clock signal width mclkw from the output value pos of the register 40. At the time of reset, a one-half value of the generated clock signal width (clkw/2) is set as the initial value of the register 40. Clkw/2−mclkw is supplied by a constant number output unit 50 disposed on the preceding stage of the adder 46; mclkw is supplied by a constant number output unit 52 disposed on the preceding stage of the subtracter 48; and clkw/2 is supplied by a constant number output unit 54. The register 40 is supplied with rst (reset signal=reset)

A register (clk) 56 is disposed on the output side of the comparator 44; the output of the comparator 44 is supplied to the CE input of the register 56; and the gating master clock signal g_mclk is input to the CLK input; and the reset signal rst is supplied to the RST input. The output Q of the register 56 is taken out as the generated clock signal CLK2, and is inverted by an inverter 58 and supplied to the D input of the register 56.

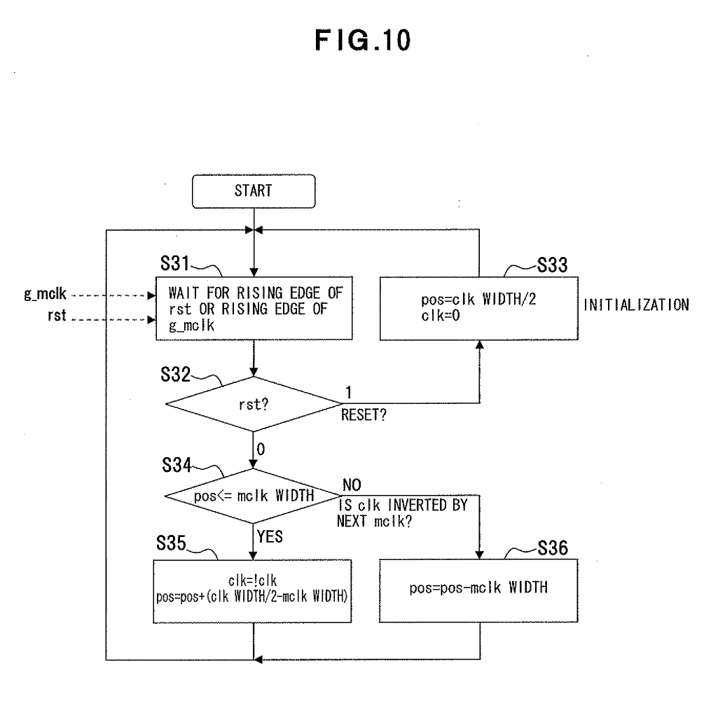

The operation of the clock generating unit 62 will be described with reference to FIG. 10. FIG. 10 is a flowchart of the clock signal generating operation of the clock generating unit 62 shown in FIGS. 8 and 9.

At the start of operation, the clock generating unit 62 waits for the rising edge of rst or rising edge (edge) of g_mclk (step S31). In this case, the rst operation and the cancellation of rst are defined as “1” and “0”, respectively, and the determination is performed (step S32). In the case of rst=1, the reset process of the registers 40 and 56 is performed to initialize the setting values of the registers 40 and 56 (step S33). In this case, after the constant number output unit 54 sets clkw/2 for the register 40 and clk=0 for the register 56, the flow is goes back to step S31. When rst=1 is cancelled and the rising edge of g_mclk occurs, the comparison process of the comparator 44 is performed after step S32 (step S34). The output value pos of the register 40 is compared with the master clock signal width mclkw. In this comparison process, it is determined whether clk is inverted by the next mclk. In the case of pos≦mclkw, clk=!clk (inversion of clk) is set, and pos=pos+(clkw/2−mclkw) is set (step S35). In the case of pos>mclkw, pos=pos−mclkw is set (step S36). With such a process, CLK2 is generated by the clock generating unit 62.

### Second Embodiment

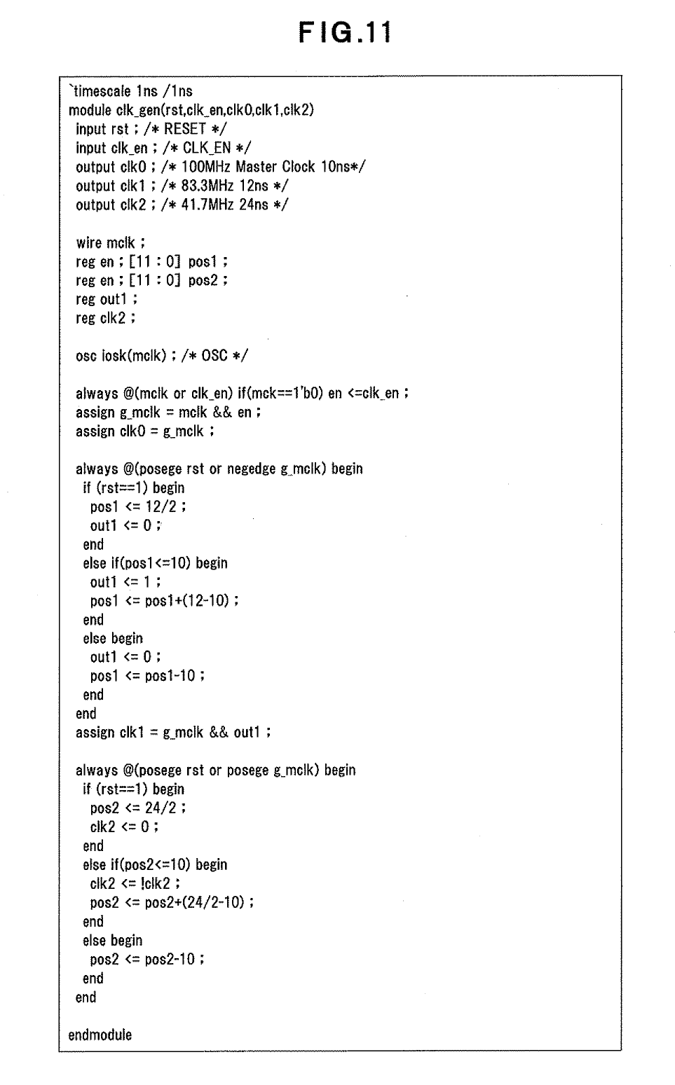

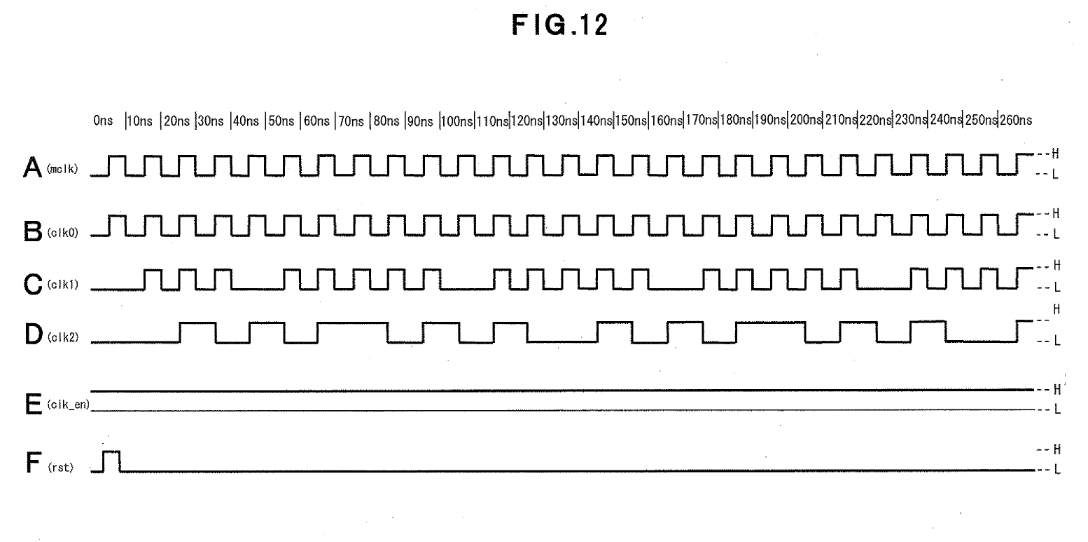

A second embodiment of the present invention will be described with reference to FIGS. 11 and 12. FIG. 11 is a list of a configuration example of the clock generating apparatus 2 described in a hardware description language (by way of example, Verilog HDL), and FIG. 12 is a timing chart of the operation and generated clock signals.

The clock generating apparatus 2 inputs rst (reset signal) and clk_en (clock generation control signal) to generate the clock signals clk0, clk1, and clk2, and clk0, clk1, and clk2 are Verilog HDL description examples that generate clock signals having clock widths of 10 [ns], 12 [ns], and 24 [ns]. In this list, process contents are described with line numbers omitted.

′timescale 1ns/1ns

module clk_gen(rst,clk_en,clk0,clk1,clk2);

input rst;/*reset*/
input clk_en;/*clk_en*/
output clk0;/*100MHz Master Clock 10ns*/
output clk1;/*83.3MHz 12ns*/
output clk2;/*41.7MHz 24ns*/
wire mclk;
reg en;
reg[11:0]pos1;
reg[11:0]pos2;
reg out1;
reg out2;
osc iosk(mclk);/*OSC*/
always@(mclk or clk_en)if(mclk==1′b0)en<=clk_en
assign g_mclk=mclk && en;
assign clk0=g_mclk;
always@(posedge rst or negedge g_mclk)begin

if(rst==1}begin

pos1<=12/2;
out1<=0;

end
else if(pos1<=10)begin

out1<=1;
pos1<=pos1+(12−10);

end
else begin

out1<=0;
pos1<=pos1−10;

end

end
assign clk1=g_mclk && out1;
always@(posedge rst or posedge g_mclk)begin

if(rst==1)begin

pos2<=24/2;
clk<=0;

end
else if(pos2<=10)begin

clk2<=!clk2;
pos2<=pos2+(24/2−10);

end
else begin

pos2<=pos2−10;

end

end

endmodule

In this description example, the “clk0” is the generated clock signal and corresponds to g_mclk (gating master clock signal). The description of “osc iosc(mclk);” indicates an oscillator module that oscillates mclk (master clock signal). The second “always” descriptive sentence (begin to end) and the next “assign” descriptive sentence generate clk1 (the generated clock signal corresponding to the above CLK1). The third “always” descriptive sentence (begin to end) and the next “assign” descriptive sentence generate clk2 (the generated clock signal corresponding to the above CLK2).

When setting mclk as shown by A of FIG. 12, clk_en as shown by E of FIG. 12, and rst as shown by F of FIG. 12 in this clock generation apparatus 2, clk0 (B of FIG. 12), clk1 (C of FIG. 12), and clk2 (D of FIG. 12) are formed.

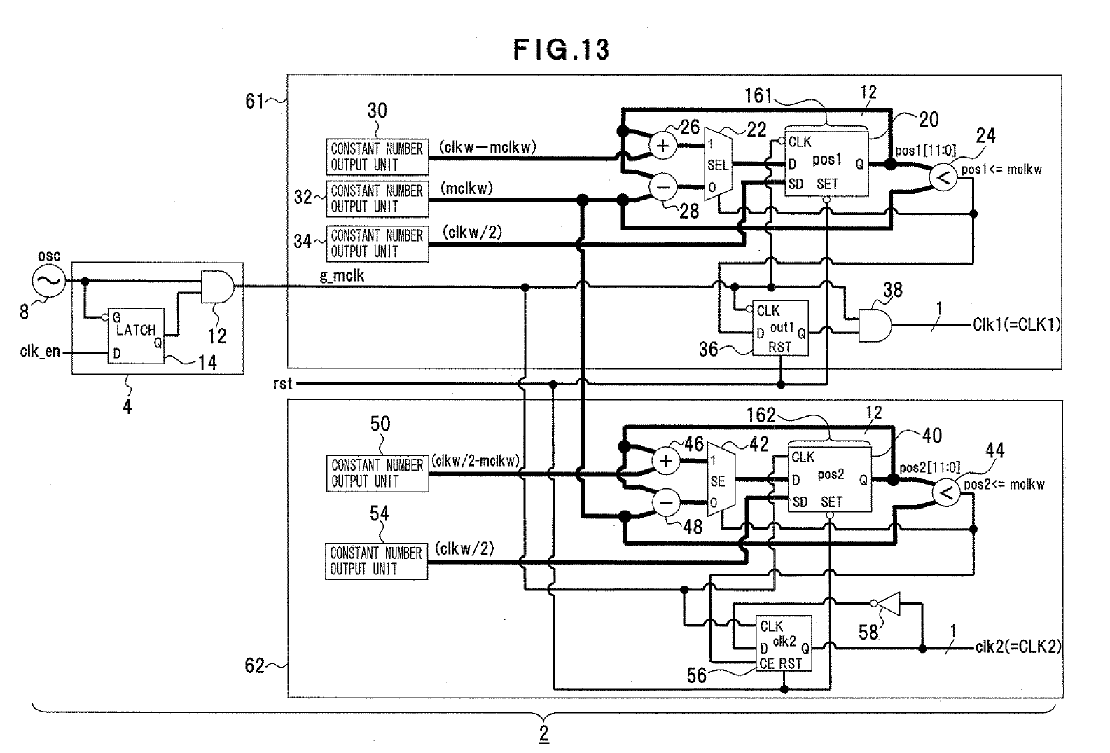

A configuration example of the clock generating apparatus 2 according to the second embodiment will be described with reference to FIG. 13. FIG. 13 is a circuit diagram of a configuration example of hardware of the clock generating apparatus 2 described in the hardware description language. In this embodiment, common reference numerals are added to the portions in common with the clock generating apparatus 2 (FIG. 1), the clock generating unit 61 (FIG. 5), and the clock generating unit 62 (FIG. 9) of the first embodiment.

This clock generating apparatus 2 is configured by the gate unit 4 and a plurality of the clock generating units 61 and 62; the gate unit 4 has the same configuration as the gate unit 4 shown in FIG. 1; the clock generating unit 61 has the same configuration as the clock generating unit 61 shown in FIG. 5; and the clock generating unit 62 has the same configuration as the clock generating unit 62 shown in FIG. 9.

The clock generating unit 61 is disposed with a register (pos1) 20 configuring the storage unit 161 as above, and the register 20 is configured by a multi-bit D-FF. To the CLK input of the register 20, g_mclk is inverted and supplied. The selector 22 is disposed on the D input side of the register 20, and the comparator 24 is disposed on the output Q side. The adder 26 and the subtracter 28 are disposed on the preceding stage of the selector 22; the outputs of the adder 26 and the subtracter 28 are selected by the output value of the comparator 24; and the selected output is supplied to the register 20. The comparator 24 compares the output value pos1[11:0] of the register 20 and the master clock signal width mclkw to determine whether the output value pos1 is within the clock signal width mclkw of the master clock signal mclk; if the value is within the clock signal width mclkw, the selector 22 selects “1” (pulse is generated); and if the value exceeds the clock signal width mclkw, the selector 22 selects “0”. To the register 20, the output value of the adder 26 is supplied if “1” is selected and the output value of the subtracter 28 is supplied if “0” is selected. The adder 26 adds the output value pos1 of the register 20 and a value of (generated clock signal width−master clock signal width) (clkw−mclkw), and the subtracter 28 subtracts the master clock signal width mclkw from the output value pos1 of the register 20. At the time of reset, a one-half value of the generated clock signal width (clkw/2) is set as the initial value of the register 20. Clkw−mclkw is supplied by the constant number output unit 30 disposed on the preceding stage of the adder 26; mclkw is supplied by the constant number output unit 32 disposed on the preceding stage of the subtracter 28; and clkw/2 is supplied by the constant number output unit 34. The register 20 is supplied with rst (reset signal reset).

A register (out1) 36 is disposed on the output side of the comparator 24 as above; the output of the comparator 24 is supplied to the D input of the register 36; and the gating master clock signal g_mclk is inverted and input to the CLK input; and the reset signal reset is supplied to the RST input. The AND circuit 38 is disposed on the output side of the register 36 and the AND circuit 38 is supplied with the output Q of the register 36 and g_mclk. The generated clock signal clk1 (=CLK1) can be acquired from the AND circuit 38.

The clock generating unit 62 is also disposed with a register (pos2) 40 configuring the storage unit 162, and the register 40 is configured by a multi-bit D-FF. To the CLK input of the register 40, the gating master clock signal g_mclk is supplied. The selector 42 is disposed on the D input side of the register 40, and the comparator 44 is disposed on the output Q side. The adder 46 and the subtracter 48 are disposed on the preceding stage of the selector 42; the outputs of the adder 46 and the subtracter 48 are selected by the output value of the comparator 44; and the selected output is supplied to the register 40. The comparator 44 compares the output value pos2[11:0] of the register 40 and the master clock signal width mclkw to determine whether the output value pos2 thereof is within the master clock signal width mclkw of the master clock signal mclk; if the value is within the clock signal width mclkw, the selector 42 selects “1” (clock inversion); and if the value exceeds the clock signal width mclkw, the selector 42 selects “0”. To the register 40, the output value of the adder 46 is supplied if “1” is selected and the output value of the subtracter 48 is supplied if “0” is selected. The adder 46 adds the output value pos2 of the register 40 and a value of (generated clock signal width/2−master clock signal width) (clkw/2−mclkw), and the subtracter 48 subtracts the master clock signal width (mclkw) from the output value pos2 of the register 40. At the time of reset, a one-half value of the generated clock signal width (clkw/2) is set as the initial value of the register 40. Clkw/2−mclkw is supplied by the constant number output unit 50 disposed on the preceding stage of the adder 46; mclkw is supplied by the constant number output unit 32 (corresponding to the constant number output unit 52 in FIG. 9) disposed on the preceding stage of the subtracter 48; and clkw/2 is supplied by the constant number output unit 54. The register 40 is supplied with the reset signal reset.

A register (clks) 56 is disposed on the output side of the comparator 44; the output of the comparator 44 is supplied to the CE input of the register 56, and the gating master clock signal g_mclk is input to the CLK input; and the reset signal reset is supplied to the RST input. The output Q of the register 56 is taken out as the generated clock signal clk2, and is inverted by an inverter 58 and supplied to the D input of the register 56.

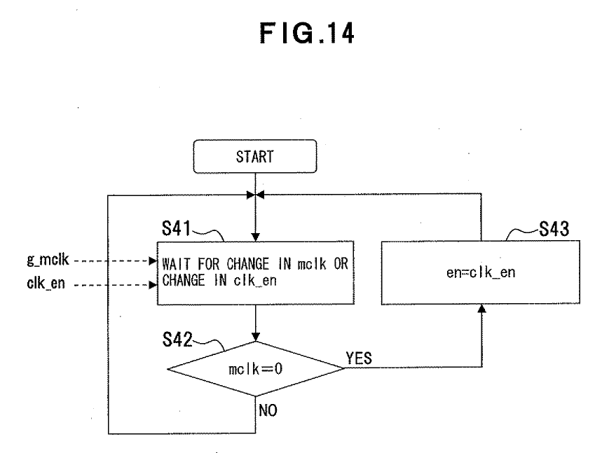

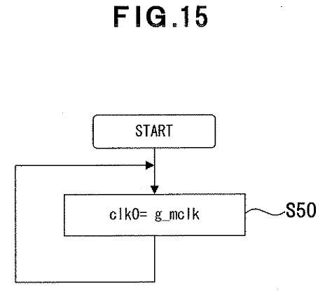

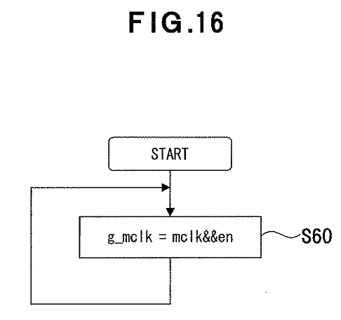

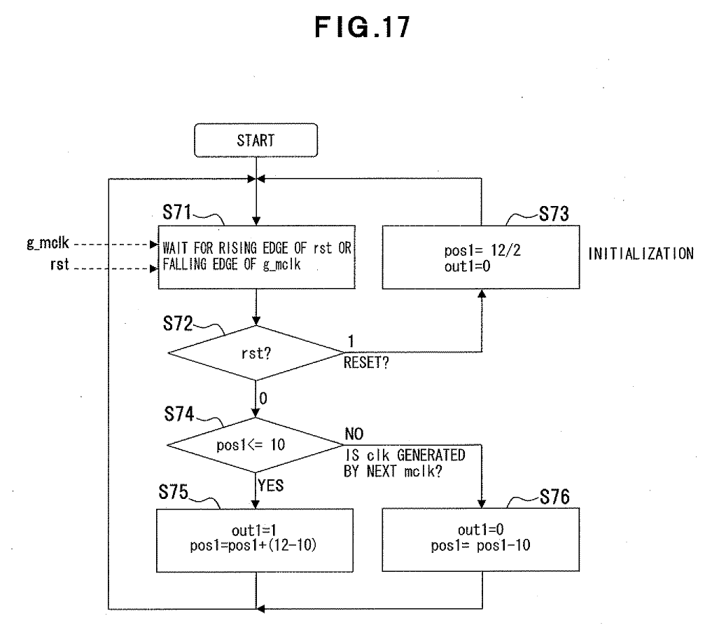

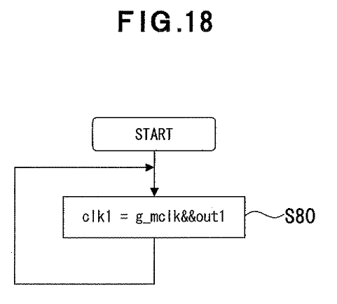

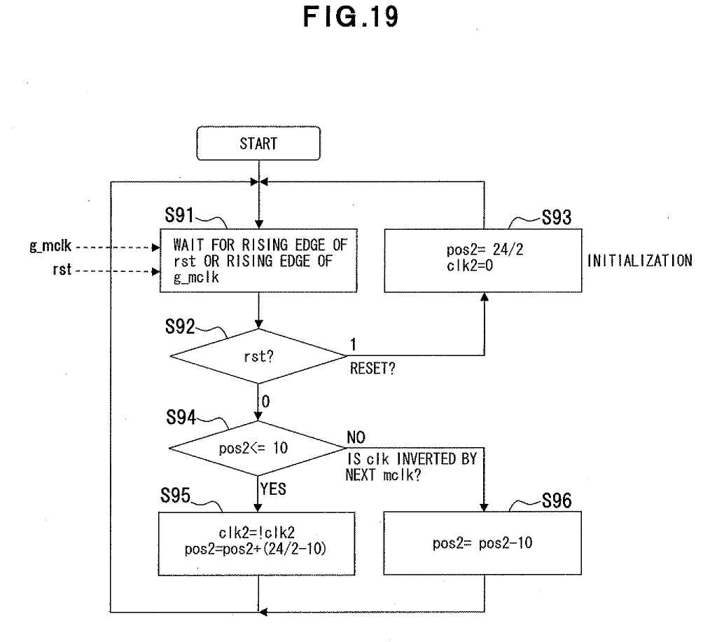

The operation of the clock generating apparatus 2 according to this embodiment will be described with reference to FIGS. 14 to 19. FIG. 14 is a flowchart of the gating operation of mclk. FIGS. 15 and 16 are flowcharts of operation of a logical circuit. FIGS. 17 and 18 are flowcharts of the clock signal generating operation of the clock generating unit 61. FIG. 19 is a flowchart of the clock signal generating operation of the clock generating unit 62.

As shown in FIG. 14, a change in mclk (master clock signal) or clk_en (clock generation controlling signal) is waited (step S41).

It is determined whether the mclk value, i.e., mclk=0 or not (step S42), and if mclk≠0, the flow goes back to step S41. If mclk=0, clk_en is input as an enable signal en (step S43), and the flow goes back to step S41. That is, clk_en is supplied as en on the basis of the state that mclk is zero. Therefore, the credibility of the clock generating operation can be enhanced.

As shown in FIG. 15, clk0 is set by g_mclk going through the gate unit 4 (step S50) and, as shown in FIG. 16, g_mclk is given by the logical product of mclk and the enable signal en (=clk_en) (step S60). This process shows operation of the AND circuit 12 (FIG. 13), and mclk is gated by en.

In this case, if the pulse of g_mclk cannot be acquired, each clock generating units 61, 62 retains the state when g_mclk is stopped.

In the clock generating process of the clock generating unit 61, as shown in FIG. 17, the rising edge of rst or the falling edge of g_mclk is waited (step S71); it is determined whether rst comes (step S72); in the case of rst=1, since this indicates reset, the register 20 is set to pos1=12/2 and the register 36 is set (initialized) to out1=0 (step S73); and the flow goes back to step S71.

At step S72, if rst=0, it is determined whether pos1<10 or not (step S74), and in this determination, it is determined whether the clock signal clk is generated by the next mclk. If pos1≦10, out1=1 and pos1=pos1+(12−10) are set (step S75), and the flow goes back to step S71. Pos1 indicates the output of the register 20; out1 indicates the output of the register 36; and (12−10) indicates the above cycle width (T1−T0).

At step S74, if pos1>10, out1=0 and pos1=pos1−10 are set (step S76), and the flow goes back to step S71. “10” indicates the above cycle width T0.

In this case, as shown in FIG. 18, clk1 is given by the logical product of g_mclk and out1 (step S80). This process indicates the operation of the AND circuit 38 (FIG. 13).

In the clock generating process of the clock generating unit 62, as shown in FIG. 19, the rising edge of rst or the rising edge of g_mclk is waited (step S91); it is determined whether rst comes (step S92); since the reset is performed in the case of rst=1, the register 40 is set to pos2=24/2 and the register 56 is set (initialized) to clk1=0 (step S93); and the flow goes back to step S91.

At step S92, if rst=0, it is determined whether pos2≦10 or not (step s94), and in this determination, it is determined whether the clock signal clk is inverted by the next mclk. If pos2≦10, clk2=!clk2 (inversion of clk2) and pos2=pos2+(24/2−10) are set (step S95), and the flow goes back to step S91. Pos2 indicates the output of the register 40; clk2 indicates the output of the register 56; “10” indicates the above cycle width T0; and (24/2−10) indicates the above cycle width (T2/2−T0).

At step S94, if pos2>10, pos2=pos2−10 is set (step S96), and the flow goes back to step S91.

With this process, the above generated clock signals clk0, clk1, and clk2 (FIG. 12) can be generated.

### Third Embodiment

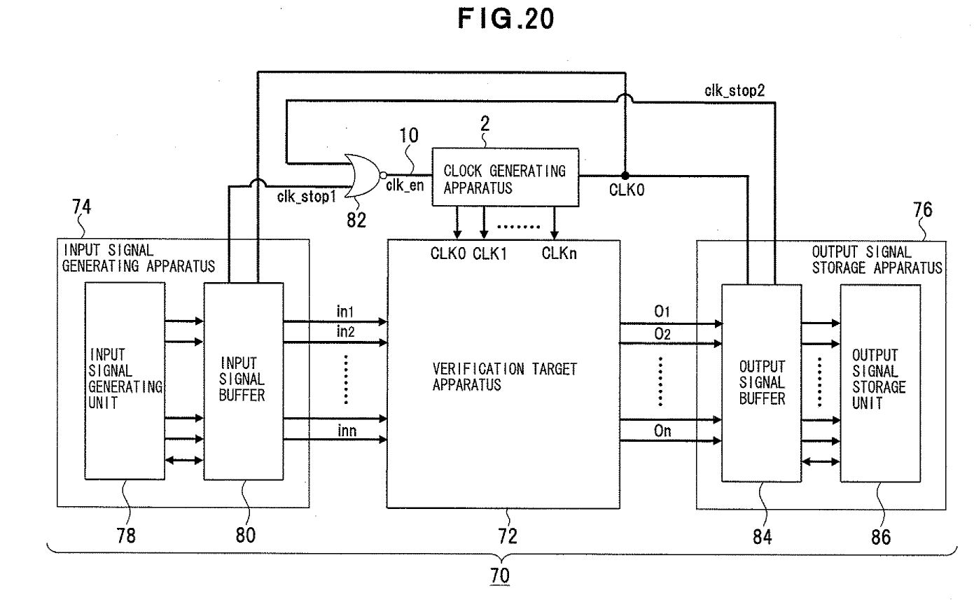

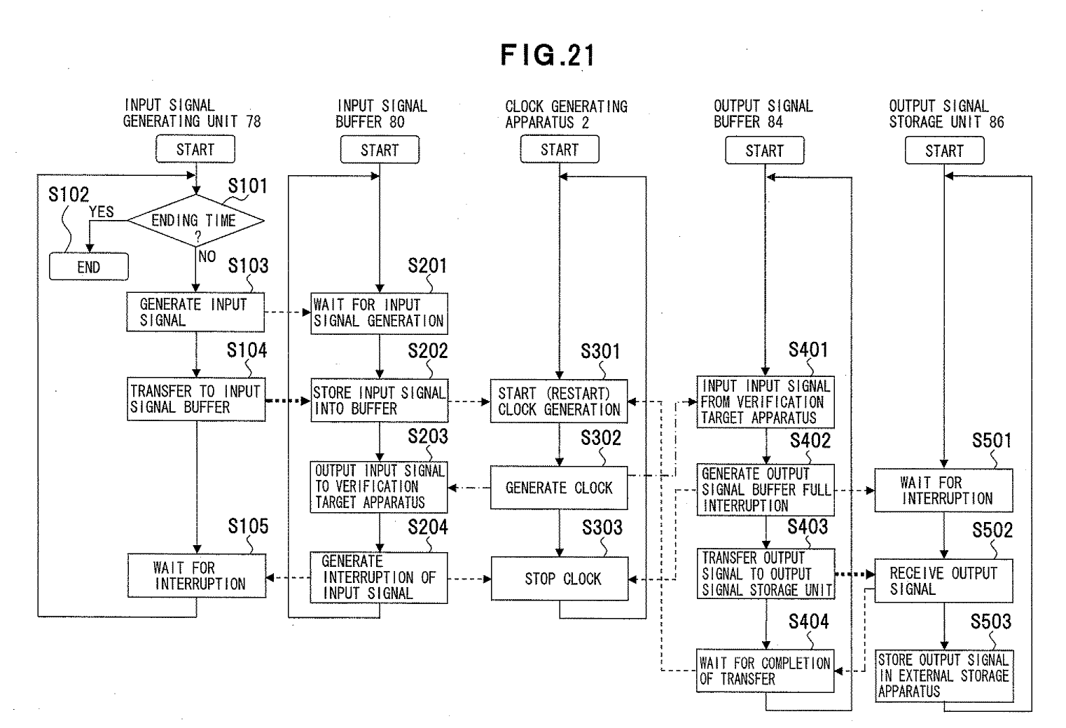

A third embodiment of the present invention will be described with reference to FIGS. 20 and 21. FIG. 20 is a block diagram of an operation verifying apparatus 70 according to the third embodiment, and FIG. 21 shows a control operation sequence.

This operation verifying apparatus 70 is used for operation verification of a verification target apparatus 72 such as a portable phone. The operation verifying apparatus 70 is disposed with the above clock generating apparatus 2, an input signal generating apparatus 74, and an output signal storage apparatus 76 corresponding to the verification target apparatus 72.

The input signal generating apparatus 74 includes an input signal generating unit 78 and an input signal buffer 80. The input signal generating unit 78 generates input signals in1, in2, . . . inn necessary for the verification target apparatus 72, and the input signal buffer 80 is configured by RAM (Random-Access Memory), etc., to store the input signal generated by the input signal generating unit 78. The input signal read from the input signal buffer 80 is supplied to the verification target apparatus 72. The input signal generating apparatus 74 generates a clock generation control signal clk_stop1 that controls the clock generating operation of the clock generating apparatus 2 in accordance with the storage and readout of the input signal in the input signal buffer 80. This clk_stop1 is supplied to the NOR circuit 82 to obtain and invert a logical sum with the clock generation control signal clk_stop2 from the output signal storage apparatus 76. The output (clk_en) of the NOR circuit 82 is supplied to the clock generating apparatus 2 to control the clock generating operation of the clock generating apparatus 2. When the readout of the input signal from the input signal buffer 80 is terminated, clk_stop1 is set to H-level (clock stop) to stop the clock generating operation of the clock generating apparatus 2, and if the readout of the input signal from the input signal buffer 80 is restarted, clk_stop1 may be set to L-level (clock restart). However, since clk_en is NOR of clk_stop1 and clk_stop2, if either input becomes H-level, clk_en becomes L and the clock generation is stopped. When the readout of the input signal is completed, the input signal buffer 80 is reset and the input signal generating unit 78 writes a new input signal into the input signal buffer 80.

The clock generating apparatus 2 includes the configuration described in FIG. 1 or FIG. 13 and generates a plurality of clock signals CLK0, CLK1, CLK2, . . . CLKn necessary for the verification target apparatus 72. The input signal buffer 80 is supplied with a readout control signal, for example, the clock signal CLK0. In the clock generating apparatus 2, the above clock generating operation is controlled by clk_en input through the NOR circuit 82. That is, if clk_en is H-level, the clock is generated and if clk_en is L-level, clock generation is stopped.

The output signal storage apparatus 76 includes an output signal buffer 84 and an output signal storage unit 86. The output signal buffer 84 takes in output signals (observed signals) O1, O2, . . . On of the verification target apparatus 72. The output signal buffer 84 is also configured by RAM (Random-Access Memory), etc. like the input signal buffer 80, to store the output signal generated by the verification target apparatus 72. The output signal buffer 84 is supplied with a write control signal, for example, the clock signal CLK0. The output signal storage apparatus 76 generates a clock generation control signal clk_stop2 that controls the clock generating operation of the clock generating apparatus 2 in accordance with the storage of the output signal of the verification target apparatus 72 or the transfer of the storage signal. This clk_stop2 is also supplied to the NOR circuit 82 and is used to control the clock generating operation of the clock generating apparatus 2. In this case, for example, when a storage amount of the output signal buffer 84 reaches the limit amount, clk_stop2 is changed to H-level to stop the operation of the clock generating apparatus 2, and if the storage of the output signal buffer 84 is restarted, clk_stop2 may be changed to L-level (clock restart).

The output signal storage unit 86 is configured by, for example, a hard disk storage apparatus, receives the transfer of the output signal (observed signal) stored in the output signal buffer 84, and stores the output signal. After the data transfer, the output signal buffer 84 is reset and stores the next output signal.

With regard to the operation verifying apparatus 70, the input signal generating apparatus 74 allows the input signal generating unit 78 to collectively generate input signals in a time width that can be stored in the input signal buffer 80 and the input signals are transferred and stored in the input signal buffer 80. During the process of generating and transferring the input signals, clk_stop1 output from the input signal generating apparatus 74 is set to H-level (clock stop), and the clock generating operation of the clock generating apparatus 2 is instructed to be stopped and the operation of the verification target apparatus 72 is stopped.

When a necessary amount of the input signals are transferred to the input signal buffer 80, the input signal generating apparatus 74 changes clk_stop1 to L-level (clock restart) to instruct the clock generating operation to be restarted. When both clk_stop1 and clk_stop2 become L, the clock generating apparatus 2 supplies CLK0, CLK1, CLK2, . . . CLKn to the verification target apparatus 72.

When the readout of the input signal from the input signal buffer 80 is terminated, i.e., when no input signal to be read exists, the input signal generating apparatus 74 instructs the clock generating apparatus 2 to stop the clock and allows the input signal generating unit 78 to generate and transfer the input signal to the input signal buffer 80, and when the transfer is terminated, the generation of the input signal is allowed to be started. In this case, after the previous transfer of the input signal to the input signal buffer 80 is terminated, the start of the generation of the input signal may be performed concurrently with the operation of the verification target apparatus 72.

This operation is repeatedly performed until all the input signals necessary for the operation verification of the verification target apparatus 72 are completely generated. The output signal storage apparatus 76 loads and accumulates the output signals (observed signals) O1, O2, . . . On of the verification target apparatus 72 into the output signal buffer 84 concurrently with the operation of the verification target apparatus 72. When the storage amount of the output signal buffer 84 reaches a predetermined amount, for example, the limit amount, the output signal storage apparatus 76 changes clk_stop2 to H-level (clock stop) and instructs the clock generating apparatus 2 to stop the clock, and the operation of the verification target apparatus 72 is stopped. The output signals O1, O2, . . . On stored in the output signal buffer 84 are transferred to the output signal storage unit 86, and when the transfer is terminated, the output signal buffer 84 is reset. Clk_stop2 is changed to L-level (clock restart) at this point to restart the clock generation operation of the clock generating apparatus 2 and to restart the operation of the verification target apparatus 72.

At the time of the data transfer of the output signal buffer 84, the clock generating operation of the clock generating apparatus 2 is stopped and, therefore, the readout control signal to the input signal buffer 80 is also stopped. The clock generating apparatus 2 is allowed to restart the clock generating operation, and the readout of the input signal from the input signal buffer 80 is also restarted correspondingly to the start of the operation of the verification target apparatus 72.

In this case, in the clock generating apparatus 2, a clock corresponding to a clock having the highest frequency of the verification target apparatus 72 is defined as mclk, and mclk can be gated by clk_en to generate or stop CLK0, CLK1, CLK2, . . . CLKn.

With regard to the operation verifying apparatus 70, the verification operation will be described with reference to FIG. 21. To monitor expiration of a preset verification time, the input signal generating unit 78 determines whether the ending time has come (step S101), and if the ending time has come, the generation of the input signal is terminated (step S102). If the ending time has not come, the input signal is generated (step S103); this input signal is transferred to the input signal buffer 80 (step S104); and the flow goes back to step S101 while waiting for an interruption (step S105).

The input signal buffer 80 waits for the generation of the input signal (step S201) correspondingly to the generation of the input signal of the input signal generating unit 78 (step S103) and receives and stores the input signal from the input signal generating unit 78 (step S202). The input signal buffer 80 outputs the input signal to the verification target apparatus 72 (step S203); if the input signal of the input signal buffer 80 is completed, an interruption is generated (step S204) for the waiting input signal generating unit 78 (step S105), which is notified of the termination of the input signal; and the flow goes back to step S201.

In response to the storage of the input signal in the input signal buffer 80 (step S202), the clock generating apparatus 2 starts or restarts the clock generation (step S301) to generate the clock signals (step S302). The generated clock signals CLK0, CLK1, CLK2, . . . CLKn are supplied to the verification target apparatus 72, and the clock signal CLK0 is also supplied to the input signal buffer 80 and the output signal buffer 84. In response to the interruption from the input signal buffer 80 (step S204), the generation of the clock signals is stopped (step S303) and the flow goes back to step S301.

The output signal buffer 84 loads and accumulates the output signal from the verification target apparatus 72 (step S401), generates an interruption when the storage amount reaches a limit (step S402), transmits the stored output signal to the output signal storage unit 86 (FIG. 20) (step S403), waits for the completion of the transfer (step S404), and goes back to step S401 after the transfer is completed.

The output signal storage unit 86 waits for an interruption (step S501) and receives the output signal from the output signal buffer 84 (step S502) in response to an interruption from the output signal buffer 84 (step S402), and this output signal is stored in an external storage apparatus, etc. (step S53), and used for the operation verification.

### Fourth Embodiment

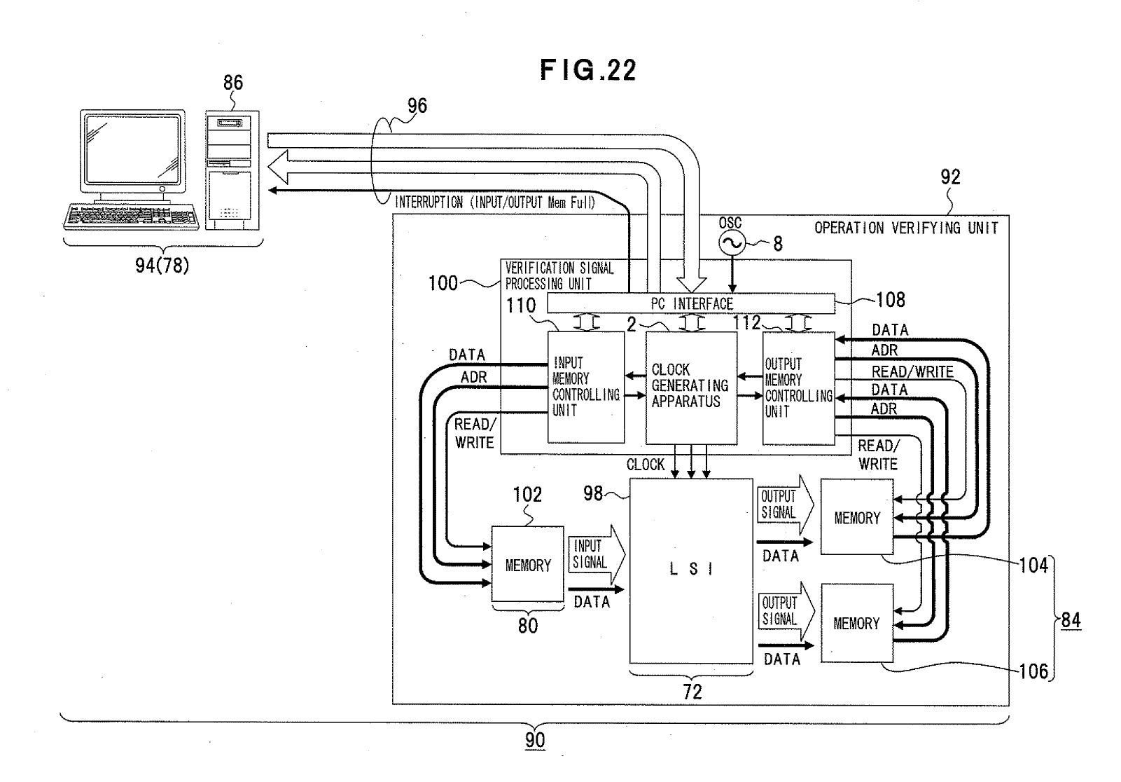

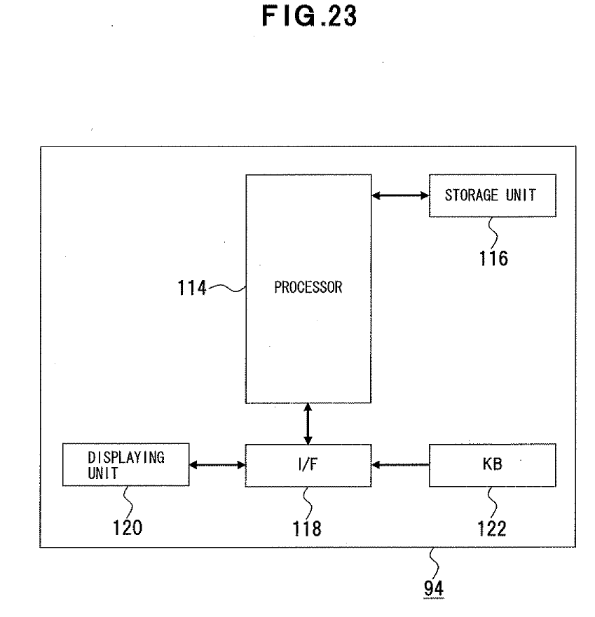

A fourth embodiment of the present invention will be described with reference to FIGS. 22 and 23. FIG. 22 is a block diagram of an operation verifying system 90 according to the fourth embodiment, and FIG. 23 is a block diagram of a configuration example of a verification control PC. In this embodiment, the same reference numerals are added to the same portions as the first embodiment (FIG. 1) and the third embodiment (FIG. 20).

The operation verifying system 90 is disposed with an operation verifying unit 92 and a personal computer (PC) 94, and the operation verifying unit 92 and the PC 94 are connected through a bus 96. The operation verifying unit 92 verifies the operation of the verification target apparatus 72 and LSI (Large Scale Integration Circuit) 98 is disposed as the verification target apparatus 72 in this embodiment.

The operation verifying unit 92 is disposed with a verification signal processing unit 100, a memory 102 as the input signal buffer 80, and memories 104 and 106 as the output signal buffer 84. The verification signal processing unit 100 configures a PC interface with FPGA (Field Programmable Gate Arrays), for example, and performs various processes such as the clock signal generation, input memory control, output memory control. The verification signal processing unit 100 is disposed with a PC interface (I/F) 108, the clock generating apparatus 2, an input memory controlling unit 110, and an output memory controlling unit 112. The PC-I/F 108 is connected to the PC 94 through the bus 96, is used for giving/receiving signals and data to/from the PC 94, and is supplied with the master clock signal mclk from the OSC 8. The clock generating apparatus 2 generates the clock signals necessary for the operation of the LSI 98, etc., and has the configuration described above (FIG. 1, FIG. 11, and FIG. 13). The input memory controlling unit 110 controls the write and read of the memory 102, stores the input signal (DATA) generated by the PC 94 into the memory 102, and performs memory control such as the readout of the signal. The output memory controlling unit 112 controls the write and readout of the output signal of the memories 104 and 106 and controls the transfer of the output signal (DATA) stored in the memories 104 and 106 to the PC 94.

The PC 94 includes an input signal generating program, performs the transfer of the input data, the transfer of the output data, the storage of the output data, etc., and specifically, configures the verification operation control of the operation verifying unit 92 as well as the above input signal generating unit 78 and output signal storage unit 86. As shown in FIG. 23, the configuration thereof includes a processor 114 configured by a CPU (Central Processing Unit) etc., a storage unit 116, an interface (I/F) 118, a displaying unit 120, a keyboard (KB) 122, etc., and the storage unit 116 stores a verification control program and configures the above output signal storage unit 86. The input signal generating unit 78 is configured by a processor 114, etc.

In the operation verification system 90, the PC 94 can perform the same operation as the above control operation sequence (FIG. 21) to control the supply, stop, and restart of a plurality of clock signals necessary for the operation of the verification target apparatus 72 such as the LSI 98 operated with a plurality of clock signals and can control the supply or stop of the input signal correspondingly to the control of the clock signals to store the output signal acquired from the verification target apparatus 72. Since the clock generating apparatus 2 can retain a phase relationship of a plurality of clock signals at a time point between the stop and restart of the clock signals in such operation verification and can start the supply of the clock signal with the phase relationship retained, the input signal supplied to the verification target apparatus 72 and the output signal acquired from the verification target apparatus 72 can continuously be recorded for a long time without changing the operation condition of the verification target apparatus 72. The clock generation operated at a practical speed can also be achieved.

Since the phase relationship of the clock signals is not affected by the stop and restart of the clock signals, the storage capacities can be set to a practical size in the input signal buffer 80 storing the input signal and the output signal buffer 84 storing the output signal; the continuous time of the input signal and output signal can be determined in accordance with the storage capacities; and the operation recording can be performed for a long time with operating state identical to continuous operation. Since an extremely large storage capacity is not necessary, relatively inexpensive memories can economically be used for the input signal buffer 80 and the output signal buffer 84.

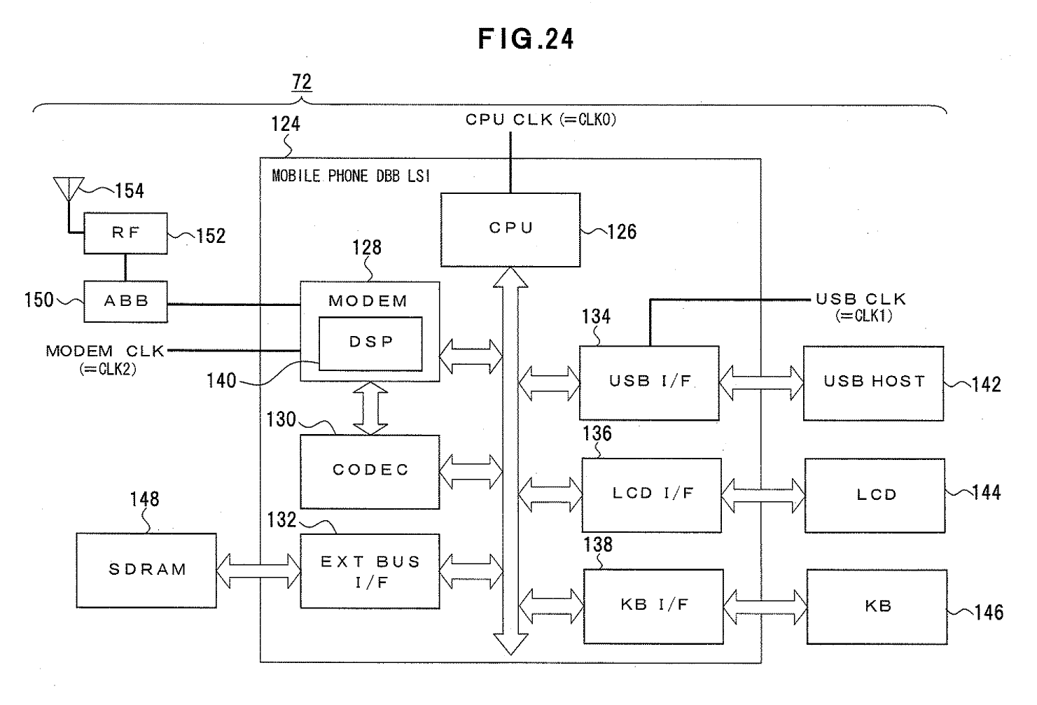

An example of the verification target apparatus 72 will be described with reference to FIG. 24. FIG. 24 is a block diagram of an example of the verification target apparatus 72, which is a mobile phone digital base band LSI (MOBILE PHONE DBB LSI) 124 and peripheral circuits.

The verification target apparatus 72, i.e., the LSI 124 includes a CPU (Central Processing Unit) 126, a modem (MODEM) 128, a codec (CODEC) 130, an output bus interface (EXT BUS_I/F) 132, a USB interface (USB_I/F) 134, an LCD (Liquid Crystal Display) interface (LCD_I/F) 136, and a keyboard interface (KB_I/F) 138, and the MODEM 128 houses a DSP (Digital Signal Processor) 140.

To operate the LSI 124, the CPU 126 needs a CPU clock signal CPUCLK, for example, CLK0; the USB_I/F 134 needs a USB clock signal USBCLK, for example, CLK1; and the MODEM 128 needs a modem clock signal MODEMCLK, for example, CLK2. These signals are supplied from the clock generating apparatus 2.

The USB_I/F 134 is connected to a USB host (USB_HOST) 142; the LCD_I/F 136 is connected to an LCD 144; the KB_I/F 138 is connected to a keyboard (KB) 146; and input signals are applied from these external circuits and devices. The input signals are supplied from the input signal generating apparatus 74.

The EXT BUS_I/F 132 is connected to an external storage device, which is an SDRAM (Synchronous Dynamic Random-Access Memory) 148; the MODEM 128 is connected to an analog base band unit (ABB) 150; and the ABB 150 is connected to a wireless unit (RF) 152. A reference numeral 154 is an antenna. That is, the output signal of the LSI 124 is supplied to these external circuits and devices and is loaded and stored by the output signal storage apparatus 76.

This verification target apparatus 72, i.e., the LSI 124 is supplied with the clock signals and input signals by the above operation verifying apparatus 70 and the output signals acquired from a series of operation can be stored for a long time to realize credible operation verification.

The features, advantages, and modifications of the above embodiments will be listed and described.

(1) In the third embodiment, the output signal buffer 84 may be incorporated into the verification target apparatus 72.

(2) Although the LSIs 98 and 124 are illustrated as the verification target apparatus 72 in the above embodiments, the verification target apparatus can be any electronic devices using a plurality of clock signals and is not limited to the LSIs 98 and 124 of the above embodiments.

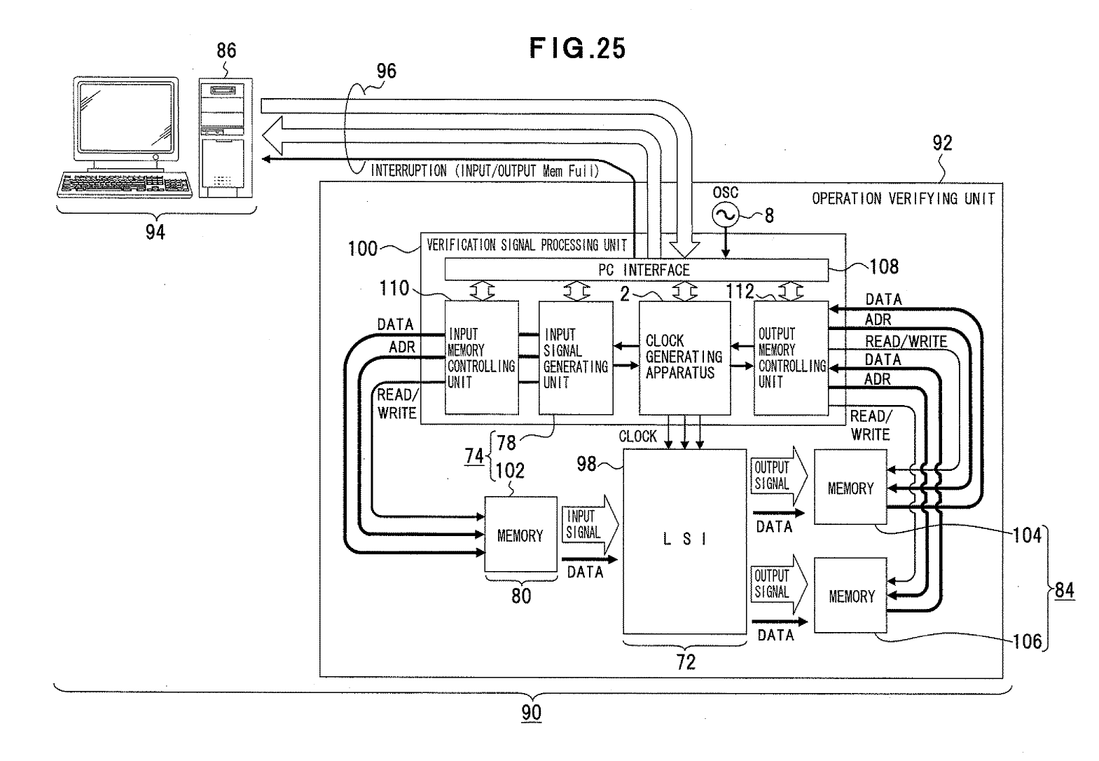

(3) In the fourth embodiment, although the input signal generating unit 78 is configured by the PC 94, the verification signal processing unit 100 may be disposed with the input signal generating unit 78 as shown in FIG. 25 to control the verification signal processing unit 100 with the PC 94 for the same verification operation.

(4) Although the output signal buffer 84 is disposed in the output signal storage apparatus 76 in the above embodiments, the output signal buffer 84 may be incorporated in the verification target apparatus 72. In such a configuration, the operation verification data can directly be taken out from the verification target apparatus 72 and the operation verification can be facilitated.

(5) In the above embodiments, the clock generating units 61 to 6N can determine for each clock cycle of the master clock signal mclk whether an edge of a clock signal with a constant clock width exists within the clock signal, and can generate a clock signal with an inconstant clock width changed at the edge of the master clock signal for an alternative clock if the edge exists.

Although the most preferred embodiments of the present invention have been described as above, the present invention is not limited to the above description and can variously be modified or changed by those skilled in the art based on the gist of the present invention described in the claims or disclosed in the modes for carrying out the invention, and of course such modifications and changes are included in the scope of the present invention.

According to the present invention, a plurality of clock signals is acquired; a phase relationship at the time of stopping the clock signals can be maintained when the generation of the clock signals is restarted; the phase relationship of the clock signals can be maintained regardless of the generation and stop of the clock signals and the restart of the generation; and for example, the present invention can be used in the operation verifying apparatus to perform the operation recording for a long time while maintaining the operation continuity of the verification target apparatus.

1. A clock generating apparatus comprising one or more clock generating units that generate a plurality of clock signals, the clock generating unit continuously generating the clock signal corresponding to a phase at a time of stop in case that clock generating operation is returned from a stop state to an operating state.

2. A clock generating apparatus comprising one or more clock generating units that generate a plurality of clock signals, the clock generating unit continuously generating the clock signal corresponding to a phase at a time of stop in case that clock generating operation is switched by a control signal and the clock generating operation is returned from a stop state to an operating state.

3. The clock generating apparatus of claim 1, wherein the clock generating unit includes a storage unit that stores the phase of the clock signal at the time of stopping the clock generating operation and wherein the clock signal is continuously generated based on the phase stored in the storage unit.

4. A clock generating apparatus comprising:
a master clock generating unit that generates a master clock signal; and
one or more clock generating units that generate a plurality of clock signals from the master clock signal of the master clock generating unit,
the clock generating unit continuously generating the clock signal corresponding to a phase at a time of stop in case that clock generating operation is switched by a control signal and the clock generating operation is returned from a stop state to an operating state.

5. An operation verifying apparatus that applies clock signals and an input signal necessary for a verification target apparatus to verify operation of the verification target apparatus, comprising:
an input signal generating unit that generates the input signal necessary for the verification target apparatus;
a clock generating apparatus that generates a plurality of clock signals necessary for the verification target apparatus; and
an output signal storage unit that stores an output signal acquired from the verification target apparatus,
the clock generating apparatus including one or more clock generating units that generate a plurality of clock signals,
the clock generating unit continuously generating the clock signal corresponding to a phase at a time of stop in case that clock generating operation is controlled by a control signal and the clock generating operation is returned from a stop state to an operating state.

6. The operation verifying apparatus of claim 5, wherein the input signal generating unit includes a storage unit that stores the input signal applied to the verification target apparatus, and wherein the input signal generating unit applies the control signal to the clock generating apparatus correspondingly to readout and read-in of the input signal of the storage unit to control the clock generating operation.

7. The operation verifying apparatus of claim 5, wherein the output signal storage unit applies the control signal to the clock generating apparatus correspondingly to read-in or readout of the output signal of the verification target apparatus to control the clock generating operation.

8. A clock generating method comprising one or more clock generating units that generate a plurality of clock signals, the method comprising the process of continuously generating the clock signal corresponding to a phase at a time of stop in case that clock generating operation is returned from a stop state to an operating state.

9. A clock generating method comprising the processes of:
allowing a master clock generating unit to generate a master clock signal;
allowing one or more clock generating units to generate a plurality of clock signals from the master clock signal; and
allowing the clock generating unit to continuously generate the clock signal corresponding to a phase at a time of stop in case that clock generating operation is switched by a control signal and the clock generating operation is returned from a stop state to an operating state.

10. An operation verifying method of applying clock signals and an input signal necessary for a verification target apparatus to verify operation of the verification target apparatus, the method comprising the processes of:
allowing an input signal generating unit to generate the input signal necessary for the verification target apparatus;
allowing a clock generating apparatus to generate a plurality of clock signals necessary for the verification target apparatus;
allowing an output signal storage unit to store an output signal acquired from the verification target apparatus;
allowing one or more clock generating units included in the clock generating apparatus to generate a plurality of clock signals; and
allowing the clock generating unit to continuously generate the clock signal corresponding to a phase at a time of stop in case that clock generating operation is controlled by a control signal and the clock generating operation is returned from a stop state to an operating state.

11. The operation verifying method of claim 10, wherein the input signal generating unit includes a storage unit that stores the input signal applied to the verification target apparatus, and wherein the method comprises the process of allowing the input signal generating unit to apply the control signal to the clock generating apparatus correspondingly to readout and read-in of the input signal of the storage unit to control the clock generating operation.

12. The operation verifying method of claim 10, further comprising the process of allowing the output signal storage unit to apply the control signal to the clock generating apparatus correspondingly to read-in or readout of the output signal of the verification target apparatus to control the clock generating operation.

13. A clock generating circuit comprising one or more clock generating units that generate a plurality of clock signals, the circuit generating the clock signal corresponding to a phase at a time of stop in case that clock generating operation is returned from a stop state to an operating state.

14. A clock generating circuit comprising:
a master clock generating unit that generates a master clock signal; and
one or more clock generating units that generate a plurality of clock signals from the master clock signal of the master clock generating unit,
the clock generating unit continuously generating the clock signal corresponding to a phase at a time of stop in case that clock generating operation is switched by a control signal and the clock generating operation is returned from a stop state to an operating state.

15. An operation verifying program of applying clock signals and an input signal necessary for a verification target apparatus to verify operation of the verification target apparatus, the program allowing a computer to perform the steps of:
allowing an input signal generating unit to generate the input signal necessary for the verification target apparatus;
allowing a clock generating apparatus to generate a plurality of clock signals necessary for the verification target apparatus;
allowing an output signal storage unit to store an output signal acquired from the verification target apparatus;
allowing one or more clock generating units included in the clock generating apparatus to generate a plurality of clock signals; and
allowing the clock generating unit to continuously generate the clock signal corresponding to a phase at a time of stop in case that clock generating operation is controlled by a control signal and the clock generating operation is returned from a stop state to an operating state.

16. The operation verifying program of claim 15, wherein the input signal generating unit includes a storage unit that stores the input signal applied to the verification target apparatus, and wherein the program allows the computer to perform the step of allowing the input signal generating unit to apply the control signal to the clock generating apparatus correspondingly to readout and read-in of the input signal of the storage unit to control the clock generating operation.

17. The operation verifying program of claim 15, wherein the program allows the computer to perform the step of applying the control signal to the clock generating apparatus correspondingly to read-in or readout of the output signal of the verification target apparatus to control the clock generating operation.

18. The clock generating apparatus of claim 1, wherein the clock generating unit includes a storage unit that stores the phase of the clock signal at the time of stopping the clock generating operation and wherein the clock signal is continuously generated based on the phase stored in the storage unit.
